(19) United States
(12) Patent Application Publication
(10) Pub. No.: US 2015/0363562 A1
(43) Pub. Date: Dec. 17, 2015

(54) System and Method for Automated Deployment and Operation of Remote Measurement and Process Control Solutions

(71) Applicant: Joachim H. Hallwachs, Chagrin Falls, OH (US)

(72) Inventor: Joachim H. Hallwachs, Chagrin Falls, OH (US)

(21) Appl. No.: 14/739,710

(22) Filed: Jun. 15, 2015

Related U.S. Application Data
(60) Provisional application No. 62/012,032, filed on Jun. 13, 2014.

(51) Int. Cl. G06F 19/00

(52) U.S. Cl. CPC G06F 19/3406; G06F 19/321; G06F 19/3418

(57) ABSTRACT

The present disclosure describes systems and methods that generate fully automated network deployment, configuration, installation, and operation of a remote measurement and process control solution which interfaces with a vertical business process, such as, for example, remote medical processes and/or collaborative telehealth systems.

### RELATED AND CO-PENDING APPLICATIONS

This application claims priority to co-pending U.S. provisional application entitled “Automated Deployment and Operation of Remote Measurement and Process Control Solutions”, Ser. No. 62/012,032 filed 13 Jun. 2014, the entirety of which is hereby incorporated herein by reference. This application is related to U.S. patent application No. (Atty. Docket No. 48753-501001US) entitled “______”, filed 15 Jun. 2015, and PCT Application No. (Atty. Docket No. 48753-501001WO) entitled “______”, filed 15 Jun. 2015, the entirety of each is hereby incorporated herein by reference.

### BACKGROUND

The next wave of evolution in the wireless industry, often termed “Internet of Things” or “IoT”, refers to the wireless attachment of machine-controlled, low-cost sensor solutions for the purpose of local data capture and upload to a centralized, automated data analysis and processing function.

The impact of the IoT paradigm in the context of specific vertical markets is the creation of dramatically improved process and state awareness, coupled with the means to implement centralized, automated monitoring and also human control functions. The IOT paradigm has the potential to dramatically lower cost, while improving the efficiency, of business processes and will also create new vertical automation and service delivery processes for new revenue opportunities. Such wireless sensor based remote monitoring solutions are comprised of data network infrastructure and local network connectivity layers that can wirelessly attach embedded sensor solutions. Typically, sensors are purpose-built for specific vertical industry frameworks, e.g., heart rate sensors used in health care, or industrial system monitoring and process automation solutions.

The underlying complexity of network infrastructure and related deployment and configuration processes, as well as the associated recurring operational aspects, all present major issues which stifle progress regarding the creation and adoption of remote sensor monitoring applications across many vertical industries, beginning with the local installation of the sensor connectivity layer. In essence, deployment complexity creates a direct dependency on network service providers, in turn coupling cost, network availability and quality, and installation related limitations inherent to any network access service, with the operation of the vertical industry solution. This dependency creates a systematic cost barrier and limiting factor to any scalable and flexible deployment of vertical IoT solutions.

In aggregate, implementation and initial deployment of a given IoT sensor solution itself cannot be realized in an automated fashion today. It cannot be realized as an embedded function of vertical industry processes and thus cannot be operated by staff with industry resident experience.

Accordingly, there is a need for systems and methods for decoupling the deployment and operation of sensor based remote monitoring and process control solutions from the use of specific network services or technology, thereby enabling enterprises across all vertical industries to autonomously deploy and control remote monitoring or process control automation solutions regardless of network services or technology.

### BRIEF DESCRIPTION OF THE DRAWINGS

FIG. 1 is a diagram for an autonomous deployment architecture according to an embodiment of the present subject matter.

FIG. 2 is a diagram illustrating aggregation and connection of multiple sensors for an autonomous deployment architecture such as shown in FIG. 1 according to an embodiment of the present subject matter.

FIG. 3 is a diagram illustrating an embodiment for embedded sensor and service control apps from multiple service vendors such as for the Sensor Network Appliance shown in FIGS. 1 and/or 2.

FIG. 4 is a diagram illustrating an embodiment for aggregating and controlling sensor services of multiple vendors such as for the embodiments shown in FIGS. 1 and/or 2.

FIG. 5 is a diagram illustrating an embodiment for an embedded service automation and control application layer such as for the Sensor Network Appliance.

FIG. 6 is a diagram illustrating an embodiment for embedded multi-media service control for multi-media devices connected to the Sensor Network Appliance.

FIG. 7 is a diagram illustrating an alternative autonomous deployment architecture according to an embodiment of the present subject matter.

FIG. 8 is a diagram illustrating an integrated multi-media communication and collaboration architecture according to an embodiment of the present subject matter.

FIG. 9 is a diagram illustrating FIG. 9 is a diagram illustrating process-integrated, flow-through service control using a centralized Sensor Network Operation Center according to an embodiment of the present subject matter.

FIG. 10 is a diagram illustrating process-integrated, sensor data flow control according to an embodiment of the present subject matter.

FIG. 11 is a diagram illustrating flow-through policy provisioning according to an embodiment of the present subject matter.

FIG. 12 is a diagram illustrating policy-based service automation according to an embodiment of the present subject matter.

FIG. 13 is a diagram illustrating an exemplary wireless sensor service policy template according to an embodiment of the present subject matter.

FIG. 14 is a diagram illustrating an exemplary collaboration service policy template according to an embodiment of the present subject matter.

FIG. 15 is a diagram illustrating exemplary prescriptive and collaboration services according to an embodiment of the present subject matter.

FIG. 16 is a diagram illustrating exemplary prescriptive automation of an episodal care path according to an embodiment of the present subject matter.

FIG. 17 is a diagram illustrating integrated telehealth collaboration services according to an embodiment of the present subject matter.

FIG. 18 is a flow chart depicting the composition of a Care Path Directive according to an embodiment of the present subject matter.

FIG. 19 is a screen shot of a Medical Care Plan according to an embodiment of the present subject matter.

FIG. 20 is a screen shot of a Medical Protocol according to an embodiment of the present subject matter.

FIG. 21 is a screen shot of a Care Path Directive according to an embodiment of the present subject matter.

FIG. 22 is an illustration of SNOC subsystems/architecture according to an embodiment of the present subject matter.

FIG. 23 is an illustration depicting a SNOC and SNA overlay of subsystems and sub-functions of FIG. 22 according to an embodiment of the present subject matter.

FIG. 24 is a block diagram showing embedded portals/apps of an SNA according to an embodiment of the present subject matter.

FIG. 25 is a block diagram showing Care Path Directives being provided to a SNOC Control and API layer of an SNA according to an embodiment of the present subject matter.

FIG. 26 is an exemplary illustration of a Mobile Care Board according to an embodiment of the present subject matter.

FIG. 27 is an illustration of a monitor screen at a central care desk according to an embodiment of the present subject matter.

FIG. 28 is an illustration of a process flow according to an embodiment of the present subject matter.

FIG. 29 is a flow chart of a manually-entered process flow according to an embodiment of the present subject matter.

FIG. 30 is a flow chart of an automatically-entered process flow according to an embodiment of the present subject matter.

### DETAILED DESCRIPTION

The following description of the present subject matter is provided as an enabling teaching of the present subject matter and its best, currently-known embodiment. Those skilled in the art will recognize that many changes can be made to the embodiments described herein while still obtaining the beneficial results of the present subject matter. It will also be apparent that for some embodiments, some of the desired benefits of the present subject matter can be obtained by selecting some of the features of the present subject matter without utilizing other features. Accordingly, those skilled in the art will recognize that many modifications and adaptations of the present subject matter are possible and may even be desirable in certain circumstances and are part of the present subject matter. Thus, the following description is provided as illustrative of the principles of the present subject matter and not in limitation thereof and may include modification thereto and permutations thereof. While the following exemplary discussion of embodiments of the present subject matter may be directed towards or reference specific systems and/or methods for remote measurement and process control solutions, it is to be understood that the discussion is not intended to limit the scope of the present subject matter in any way and that the principles presented are equally applicable to other systems and/or methods for remote measurement and process control solutions.

Those skilled in the art will further appreciate that many modifications to the exemplary embodiments described herein are possible without departing from the spirit and scope of the present subject matter. Thus, the description is not intended and should not be construed to be limited to the examples given but should be granted the full breadth of protection afforded by the appended claims and equivalents thereto.

With reference to the Figures where like elements have been given like numerical designations to facilitate an understanding of the present subject matter, various embodiments of a system and method for remote measurement and process control solutions are described.

The present disclosure describes novel systems and methods for embodiments that generate fully automated network deployment, configuration, installation, and operation, as part of a tight integration in vertical business processes. These embodiments integrate with standard vertical technology, business processes and practices, to generate the necessary input that drives automation. These embodiments enable simple installation, capable of being carried out by non-technical people with a standard level of expertise, as employed in respective verticals.

As a non-limiting example, existing and open standards based medical prescription and business processes, regulated and standardized across the U.S. health care industry, are implicitly used to generate a generic platform solution that provides automation of deployment of home-based remote patient monitoring and telehealth collaboration services, particularly in the context of patients with medical conditions or post-operational medical episodes of home care. The resulting solution can be installed by non-technical people, e.g., visiting nurses or home care staff.

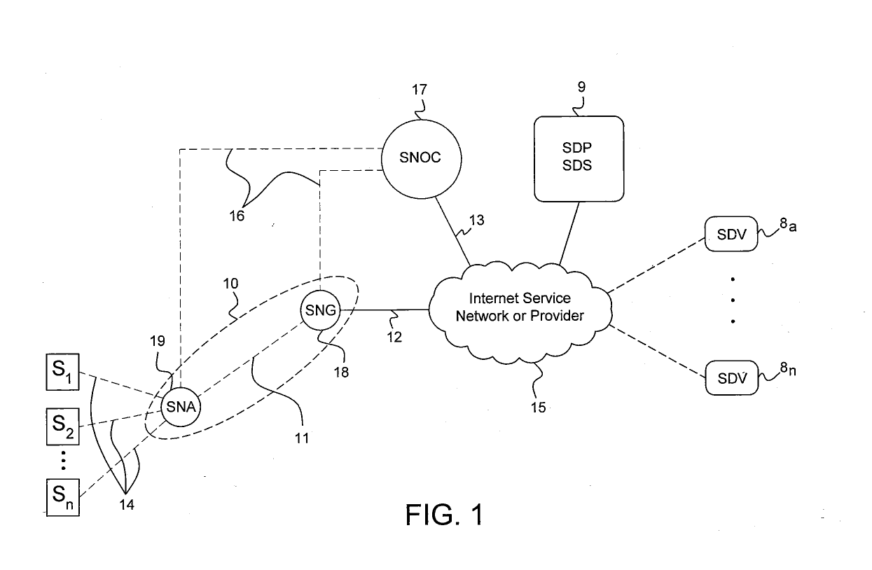

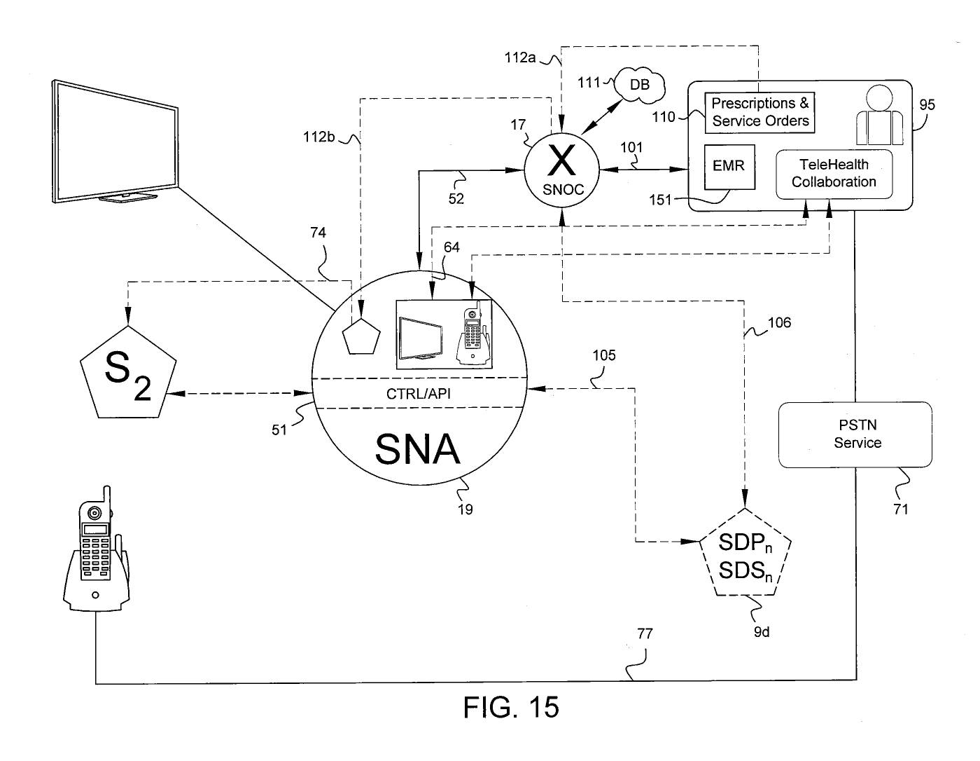

A functional framework for the present embodiments is captured in FIGS. 1 through 14, which aim to depict and explain key functions of the present disclosure. Without implying limitations to the applicability of the present disclosure, these functions will be presented in more detail to describe embodiments, targeting the automated deployment of remote measurement, patient monitoring, as well as home care and multi-media collaboration services in health care and telemedicine applications. Further related details are depicted in FIG. 15 and beyond.

The present disclosure contemplates a system and solution that allows automated deployment, and simplified installation by non-technical personnel, of sensor-based remote monitoring and process automation solutions. In order to facilitate this automation, the disclosure, in certain embodiments, contemplates the concurrent operation of multiple sensors, multiple types of sensors, as well as multiple control and service applications, within the same remote location. In certain embodiments, the present disclosure proposes a solution where the data network functionality and local sensor connectivity and embedded control functions are logically entirely decoupled in implementation, installation and operation. This paradigm is termed Autonomous Deployment Architecture. This architecture fundamentally enables vertical enterprises to autonomously design, implement, deploy, and control industry specific remote measurement and process control solutions and services.

Autonomous Deployment Architecture

The high level scope of the present disclosure is represented as part of FIG. 1, in the form of three functional components that can be, in one possible embodiment, comprised of a local sensor network area 10, and a centralized Sensor Network Operation Center (“SNOC”) 17. The local sensor network area is comprised of two sub-functions, the Sensor Network Gateway (“SNG”) 18 and the Sensor Network Appliance (“SNA”) 19. In an autonomous deployment architecture all sensor network functions are connected to any external component via open and global standards based connectivity, as depicted by connections 12, 13, and 14.

In an embodiment, the SNG 18 is a logical network function that can be an embedded function of the SNA 19, forming a single unit for deployment. The SNG function can be connected to an arbitrary Internet Service Network or Provider 15, including any fixed or wireless ISP service network technology. The present disclosure targets the use of configuration-free interfaces 12, such as Ethernet or telephone cables, installed by laymen without special instructions. However, use of WiFi or mobile data service connectivity are also contemplated.

The centralized SNOC 17 is hosted in a highly secure data center location that is connected to the Internet Service Network 15 typically via high-speed connections 13 provided by a hosting service provider. Certain embodiments also contemplate that one or more Sensor Data Processing (“SDP”) and Sensor Data Storage (“SDS”) unit(s)/application(s) 9 and/or one or more Sensor Data Visualization (“SDV”) units/applications 8a through 8n be operatively connected to network 15.

Connectivity between SNA 19 or SNG 18 is targeted to use secure, open and global standards based wireless technology 11, such as WiFi, but is not limited to that option and may be a wired connection. Operational connectivity 16 between SNA 19 and/or SNG 18 and the centralized SNOC 17 is realized using highly secure and encrypted Internet protocols that may be based on global Internet standards, such as HTTPS.

Finally, the local SNA 19 is connected to attached sensors s₁, s₂, . . . sₙ, via global and open standards based wireless or wired interfaces 14. Such interfaces could be based on Bluetooth, low-energy Bluetooth, WiFi, or other standard wireless network interface technology.

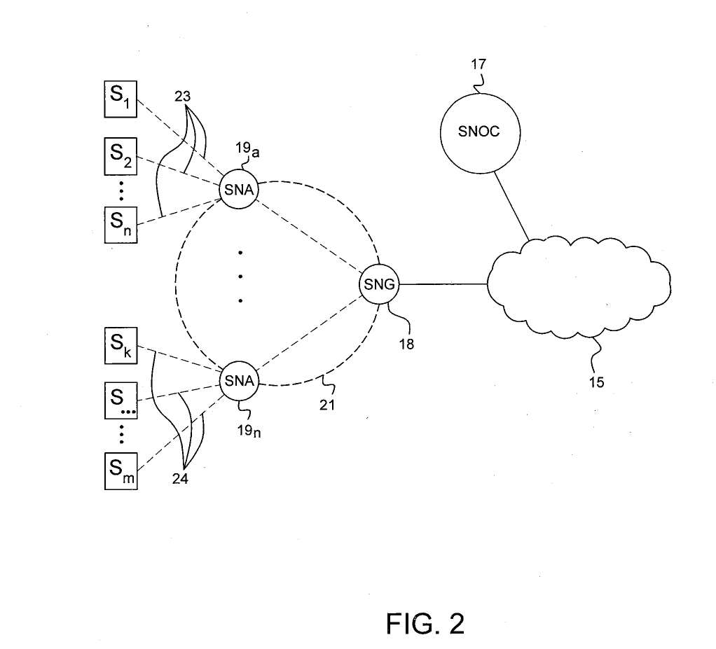

The present disclosure is particularly suited for, but not limited to, the use in context of multiple sensor and control automation solutions in the same remote location, potentially, but not limited to, employing multiple sensors, sensors of different types, and operating concurrently within the same remote location. This functionality, termed multi-sensor aggregation, is depicted in FIG. 2.

Aggregation and Connection of Multiple Sensors

The present disclosure contemplates an embodiment, depicted in FIG. 2, where multiple sensors s₁ through sₙ and sₖ through sₘ can be attached to the same local sensor network area 21, each using their own, and optionally different, connection technologies as shown by connections 23 and 24.

In this context, FIG. 2 also depicts another embodiment which employs multiple SNAs 19a through 19n within the same local sensor network area 21 to connect with one or more of the multiple sensors s₁ through sₙ and sₖ through sₘ, which may be positioned in different locations, such as rooms in a household or office building. Sensors are typically able to connect to any SNA in the local sensor network area 21, including the option to switch connection from one SNA to another SNA.

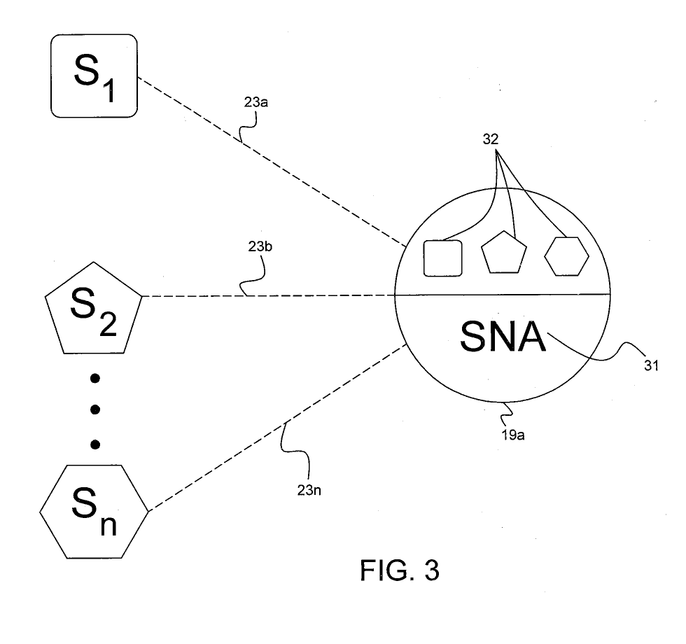

The present disclosure is particularly suited for, but not limited to, the use in context of multiple sensor and control automation solutions, including the embedded operation of multiple Sensor and Service Control Apps, that can be offered or sold by different vendors. This functionality, termed multi-vendor sensor service aggregation and control, is further discussed below with reference to FIG. 3.

Aggregating and Controlling Sensor Services of Multiple Vendors

The present disclosure allows concurrent operation of multiple, Sensor and Service Control Apps (applications) 32, which may be automatically installed on the SNA 19a as depicted in FIG. 3. The various Sensor and Service Control Apps 32 may be different, as depicted by the different shapes in FIG. 3. Preferably, a particular Sensor and Service Control App 32 matches up with a particular sensor, as depicted in FIG. 3 by matching the sensor shape with a Sensor and Service Control App of like shape.

Sensor and Service Control Apps 32 may be associated with different types of sensors and different global and open standards based connection technologies, depicted by 23a, 23b, and 23n of FIG. 3. Each control application and the associated sensors can be developed and/or sold by different vendors.

The SNA 19a sub-function 31 has the ability to automatically download appropriate Sensor and Service Control Apps 32. This is achieved by the embedded use of an operating system in the SNA sub-function 31. In an embodiment, this may be an operating system that offers automated application download and installation capability.

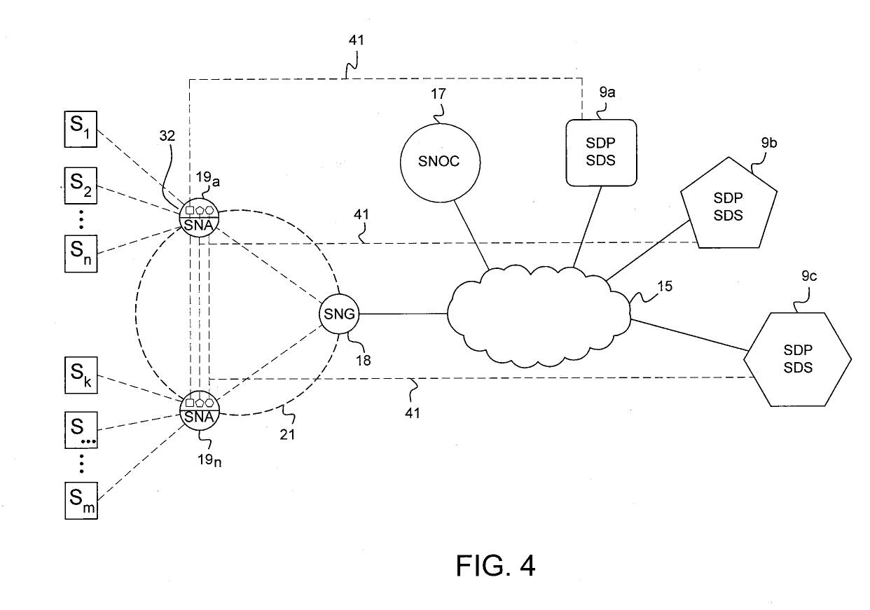

Embodiments of the present disclosure provide a locally embedded, open control application and connection framework that provides options for automated installation of embedded Apps, such as the Sensor and Service Control Apps 32. In performing the function of multi-vendor sensor aggregation, embodiments of the disclosure allow embedded and concurrent operation of multiple Sensor and Service Control Apps 32, designed and sold by multiple vendors. Hence, multi-sensor, multi-vendor solutions can be added, expanded, and/or reduced upon in functionality, either step-by-step, or over time, as needed, to optimize or expand process automation or services. This functionality, sometimes termed herein as embedded multi-vendor service control, is depicted in FIG. 4.

Aggregating and Controlling Sensor Services of Multiple Vendors

Embodiments of the present disclosure contemplate the aggregation of multiple sensors, manufactured by multiple vendors, and controlled by individual embedded Sensor and Service Control Apps that can operate concurrently on an SNA, such as SNA 19n depicted in FIG. 4.

In addition, multi-vendor sensor operation is facilitated by means of open standards based connectivity, allowing each sensor or vendor specific application to establish its own independent control and data connectivity 41 with respective matched SDS or SDP sub-systems, as depicted as devices 9a, 9b, and 9c in FIG. 4.

Embedded Service Automation and Control

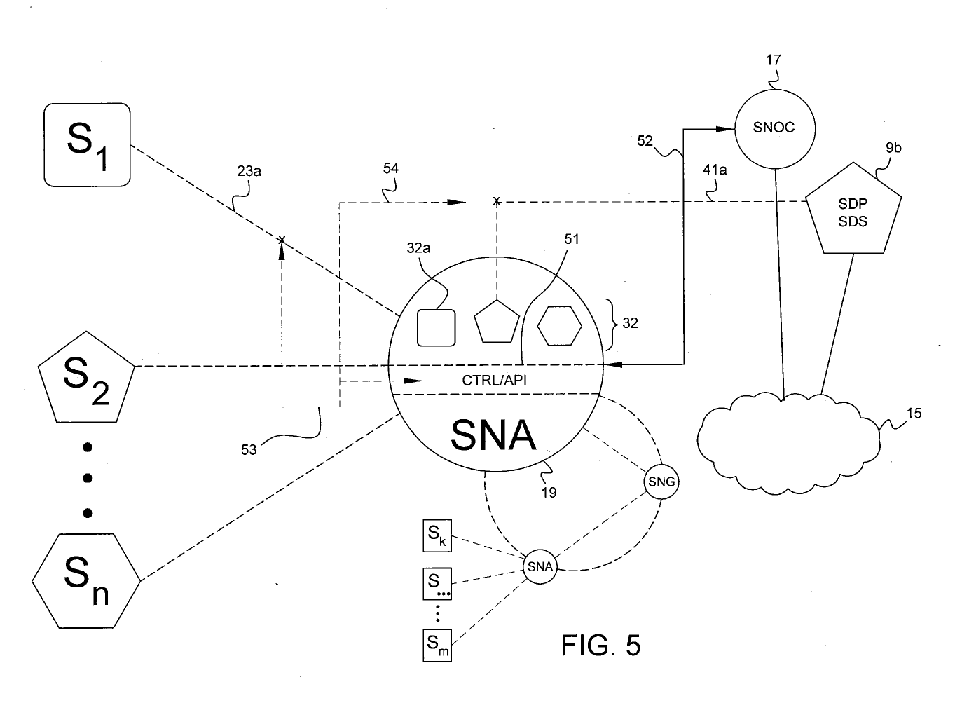

The present disclosure employs embedded process and service automation methods and control mechanisms that interact with the embedded Sensor and Service Control Apps 32 by means of an open API and control layer, embedded in the SNA, and securely connected with the hosted, centralized sensor network control function SNOC 17. This functionality, termed embedded service automation and control, is depicted in FIG. 5.

As depicted in FIG. 5, a service automation and control application layer CTRL/API 51 may be embedded in one or more of the SNAs. The embedded CTRL/API layer itself is centrally controlled by the SNOC 17, using highly secure and encrypted transport and messaging technology shown as connection 52.

In the embodiment that is depicted in FIG. 5, the SNA embedded CTRL/API layer 51 controls the operational framework of embedded Sensor and Service Control Apps 32. In certain embodiments, the CTRL/API layer 51 also controls (shown as 53) the connection 23a between a particular Sensor and Service Control App 32a and its matched sensor s₁, as well as controlling (shown as 54) the connection 41a between the Sensor and Service Control App 32a and its related SDP and SDS subsystems of device 9b. In this way, the CTRL/API layer 51 can control the message data flow amongst a matched group of sensor, embedded Sensor and Service Control App and SDS and SDP subsystems/functions. The embedded CTRL/API layer 51 operates under automated control of the SNOC 17, which facilitates centralized service automation.

Embedded Multi-Media Service Control

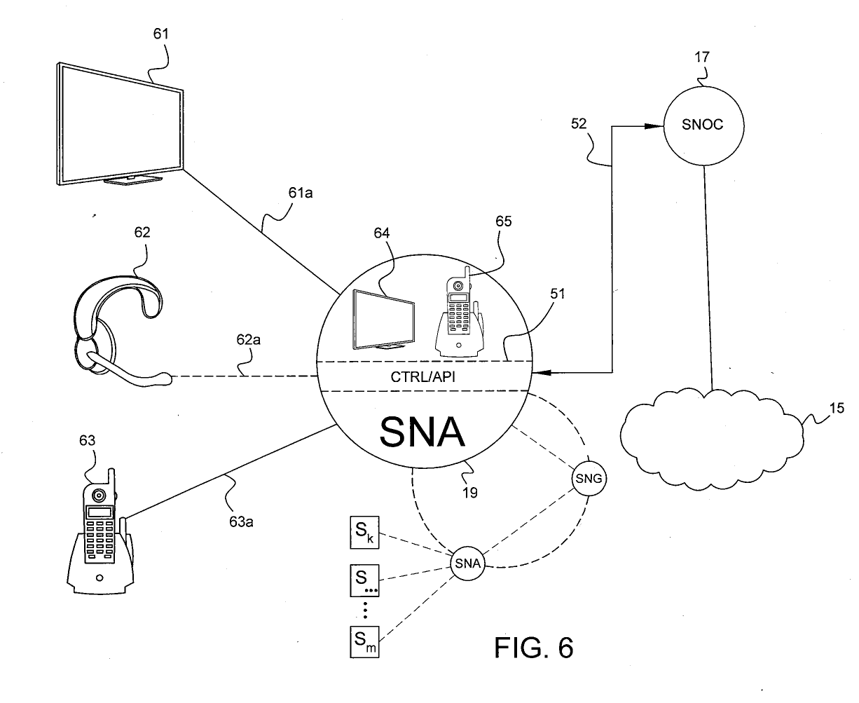

The present disclosure employs embedded process and service automation methods that use open and standards based communication, collaboration and alerting interfaces connected to the SNA. This function, termed embedded multi-media service control, is depicted in FIG. 6.

FIG. 6 depicts another embodiment of a local SNA sub-system. As shown SNA 19 is connected, via embedded CTRL/API layer 51 and wired and/or wireless interfaces, to a variety of telephony 63, audio 62, and/or video 61 equipment. In the embodiment shown, the embedded CTRL/API layer 51 may contain various connectivity options, as well as the operating framework of Multi-Media Service Control Apps, shown as Video Service Control App 64 and Telephony Service Control App 65. Each of these control apps may be controlled by the SNOC 17 via the SNA embedded CTRL/API layer 51.

In an embodiment, the SNA 19 may be connected via wired or wireless connection 61a to a television or monitor screen 61. Video output capability is handled by standard drivers in the SNA operating system, and can be used and controlled by optional embedded video display and content streaming applications, such as embedded Video Service Control App 64. Video connection options, embedded drivers, as well as optional video applications, are controlled by the SNOC 17 via the SNA 19 embedded CTRL/API layer 51.

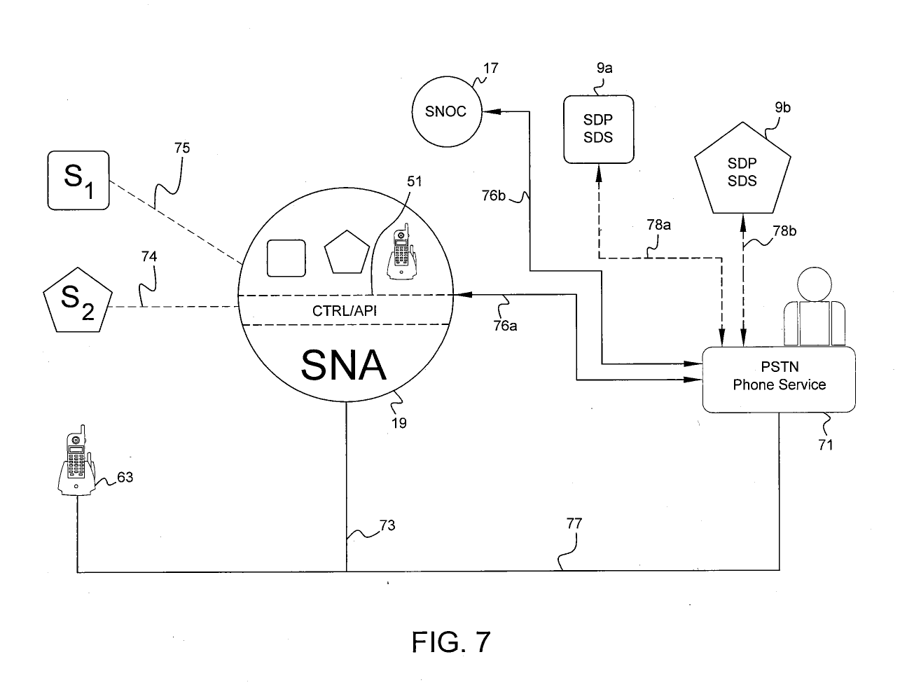

In an embodiment, the SNA 19 may be connected via a wired or wireless connection 63a to telephony equipment 63, which typically, but not necessarily, is located locally to the SNA 19. Telephony service capability is optionally handled by standard drivers in the embedded SNA operating system, and can be used and controlled by optional embedded Telephony Service Control App 65. Alternatively, local or remote telephone equipment can be connected to a private or enterprise telephony service line, both of which can communicate with the embedded Telephony Service Control App 65, through open and global standards-based telecommunication protocols, as depicted by connection 77 in FIG. 7. In both cases, the telephony service is controlled by the SNOC 17 via secure transport connection 52 to the SNA 19 embedded CTRL/API layer 51.

In an embodiment, a wired or wireless connection 62a may be connected to local or remote audio equipment 62. An exemplary, non-limiting, embodiment may include a wireless Bluetooth audio device, such as a Bluetooth hearing aid, as the remote audio equipment 62. Bluetooth audio service may be handled by standard drivers in the embedded SNA 19 operating system and may be used and/or controlled by one or more of the optional Multi-Media Service Control Apps 64 or 65 or a separate Multi-Media Service Control App (not shown) for Bluetooth. Bluetooth audio connection options, embedded drivers, as well as optional service applications, are controlled by the SNOC 17 via the SNA 19 embedded CTRL/API layer 51.

PSTN Redundancy and Service Operation

The present disclosure, in one optional embodiment, employs embedded telephony interface and service control capability used for dial-up data connectivity and transport. Dial-up data service capability is handled by standard drivers in the embedded SNA 19 operating system. This function, termed PSTN Redundancy and Service Operation, is depicted in FIG. 7.

As depicted in FIG. 7 in some embodiments the SNA 19 may be connected to a traditional public switched telephone network (“PSTN”) 71 via a wired or wireless interface 73, e.g., in a shared configuration with an existing on-premise telephone service 63 which connects to the PSTN via connection 77. Alternatively, SNA 19 may connect on a dedicated line 76a with PSTN 71. In either configuration, the SNA 19 may employ, for example, embedded open and global standard dial-up capability, such as V.92, to connect to the SNOC 17 through the PSTN 71 via connection 76b. All SNA attached connections, their embedded drivers, as well as their respective service applications, are controlled by the SNOC 17 via the SNA embedded CTRL/API layer 51, which may optionally use redundant, low-speed dial-up data connectivity.

As the embodiment in FIG. 7 shows, PSTN 71 dial-up data connectivity between SNA 19 and SNOC 17 can serve as a reliable redundancy option for the standard IP based service access as discussed above and shown in FIG. 1, or, in other embodiments, the above-described PSTN arrangement may function in a stand-alone operational mode, when fixed or wireless broadband connectivity is not installed, or not available.

The embodiment in FIG. 7 shows the aggregation of several wireless sensors, s₁ and s₂, connected to SNA 19 via connections 74 and 75, respectively. In an embodiment, aggregated sensor data may not require high data transport capacity, so the data needs of connections 74 and/or 75 may be satisfied with a dial-up connection. In some embodiments, it may be possible to use dial-up connectivity and PSTN operation as a standard deployment mode for such sensor network applications. In other embodiments, SDP/SDS sub-systems 9a and 9b may each connect with PSTN 71 via connections 78a and 78b, respectively, which may be wired or wireless connections.

Integrated Multi-Media Communication and Collaboration

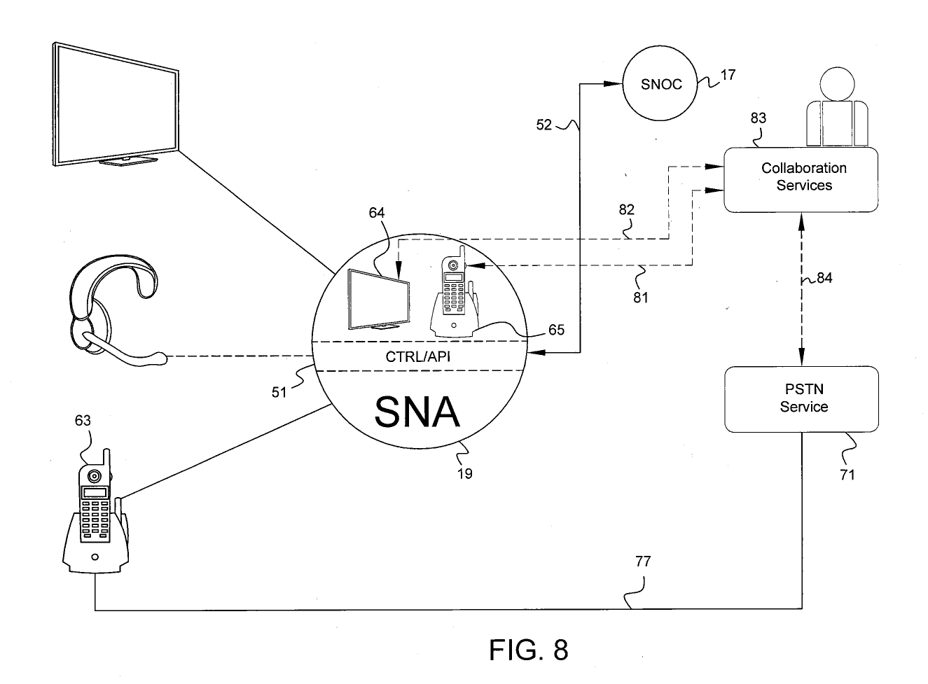

The collaborative function discussed in certain embodiments may not be limited to any particular telecommunication service provider or technology. Hence, it can be implemented, but is not limited to operate, as a fully integrated function of vertical enterprise communication or multi-media collaboration services. This allows seamless integration with collaborative enterprise and industry processes, especially desirable when remote locations are end-user service delivery locations. This function, termed Integrated Multi-Media Communication and Collaboration, is depicted in FIG. 8.

The embodiment shown in FIG. 8 depicts the SNA 19 with embedded operation of Multi-Media Service Control Apps, such as Video Service Control App 64 and Telephony Service Control App 65. In an embodiment, one or more of these Multi-Media Service Control Apps may be integrated with a Collaboration Service 83 via a dedicated communication connection 81 and/or via a multi-media collaboration connection 82. The Collaboration Service 83 may be a public-connected or enterprise-connected service.

As shown in FIG. 8, public or enterprise Collaboration Service 83 may have standard interworking functions 84 with traditional phone service providers such as PSTN 71, which in turn provide service to traditional local and/or non-local phone lines 77. Thus, SNA 19 embedded applications can control, originate, and even automate telephone connections within a local sensor network area, such as local sensor network area 10 in FIG. 1 or local sensor network area 21 in FIG. 2. In other embodiments, SNA 19 embedded applications may also perform these functions where SNA 19 is not directly connected to the local telephone equipment 63.

In certain embodiments, operation of unified communication and collaboration applications, as well as the connectivity to SNA 19 attached devices, are controlled by the SNOC 17 via secure transport connection 52, as described above, to the embedded CTRL/API layer 51 of SNA 19.

Process-Integrated, Flow-Through Service Control

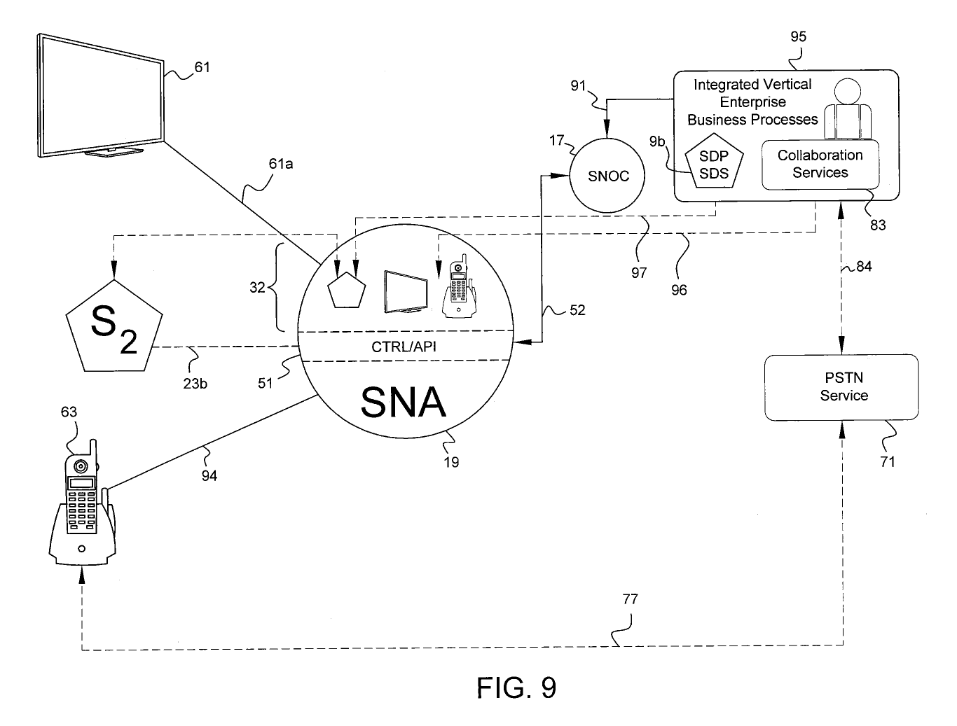

As shown in FIG. 9, embodiments of the present disclosure may implement embedded methods to exchange control information, of any kind, between vertical enterprise business processes and the centralized control entity SNOC 17. In this context, SNOC 17 may provide a dedicated function for a given enterprise, or provide a function that is shared between several enterprises. This interface combines vertical process integration of the present disclosure with automated deployment and operation capability enabling Process-Integrated, Flow-Through Service Control.

FIG. 9 illustrates embodiments where there is integration of the centralized SNOC 17 with Integrated Vertical Enterprise Business Processes 95, via an Information Exchange Interface 91. The control function of SNOC 17 extends to a local sensor network area via the secure transport connection 52 to the embedded CTRL/API layer 51 of SNA 19. In embodiments, the embedded CTRL/API layer 51 controls all attached interfaces to video and/or multi-media devices 61 (via connection 61a), sensors, such as s₂ shown (via connection 23b), and optional telephony equipment 63 (via connection 77 or, alternatively, connection 63a shown in FIG. 6), as well as the embedded operation of the respective related Sensor or Multi-Media Service Control Apps 32 discussed above.

FIG. 9 further illustrates, for certain embodiments, how embedded Sensor or Multi-Media Service Control Apps 32 are tied back into the Integrated Vertical Enterprise Business Processes 95, which may include, for example, SDP/SDS subsystem 9b and Collaboration Services 83, thereby creating an end-to-end application paradigm for automated remote sensor network solutions (nominally shown as connection 97) and related embedded collaboration applications (nominally shown as connections 94 and 96). This combination provides cost-effective, automated local monitoring, collaboration and process control, by means of direct machine-to-machine data exchange, while facilitating human information and decision flow.

Process-Integrated Sensor Data Flow Control

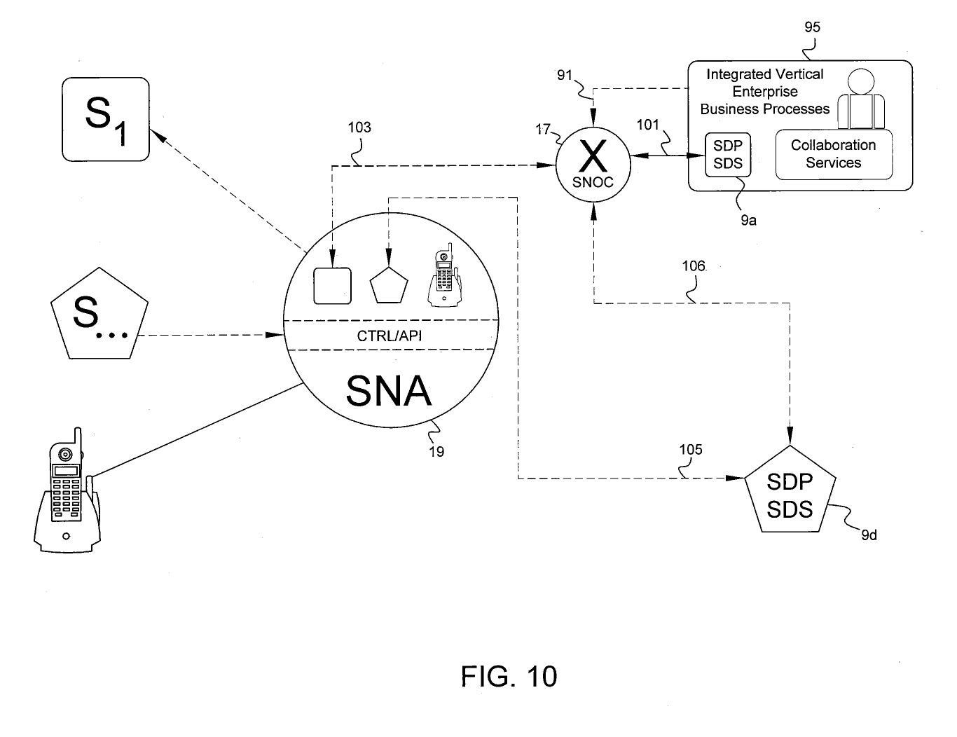

As shown in FIG. 10, the present disclosure implements open interface capability regarding the exchange of sensor network related data, including, but not limited to, actual sensor measurement results, locally processed measurement results and related alerts and collaboration messages, as well as status information related to the sensor itself as it relates to the project. This functionality is depicted as Process-integrated Sensor Data Flow Control.

FIG. 10 shows an embodiment including an enterprise Information Exchange Interface 101, spanned between the SNOC 17 and sensor data driven vertical enterprise business processes 95, specifically process integrated SDS and SDP sub-functions 96. The SNOC 17 implements a specific data and message exchange model between the SNOC 17 and the enterprise business processes 95 for the purpose of aggregating data from different sensor vendors, applications, and sensor project status data and alerts. In the SNOC 17, a Data and Message Exchange Function streamlines SDS and SDP implementations for enterprises, importantly in compliance with vertical industry requirements, implicitly providing sensor vendors with compliant Information Exchange Interface 101 capability.

One embodiment of the present disclosure as depicted in FIG. 10 is the ability to provide within SNA 19 the embedded Sensor and Service Control Apps 64 and 65, as discussed previously, with secure data and message transport interface 103 to the SNOC 17 data and Message Exchange Function to transform and forward relevant and real-time status data and alert information on to the enterprise business processes 95 via the Information Exchange Interface 101.

Another embodiment of the present disclosure depicted in FIG. 10 is the ability to provide SNOC 17 data and message exchange capability to third party SDP and/or SDS systems of sensor vendors 9d, e.g., when raw sensor data sent to the sensor cloud (e.g., cloud 15 in FIG. 1) from SNA 19 via interface 105 needs to be stored and/or pre-processed before the enterprise is able to integrate the information with its business processes. In this embodiment, the SNOC 17 Data and Message Exchange Function transforms data sent from the external SDP function 9d, received via interface 106, and forwards the information on to the enterprise business processes 95 via the Information Exchange Interface 101 in a manner compliant with vertical business requirements.

Flow-Through Policy Provisioning

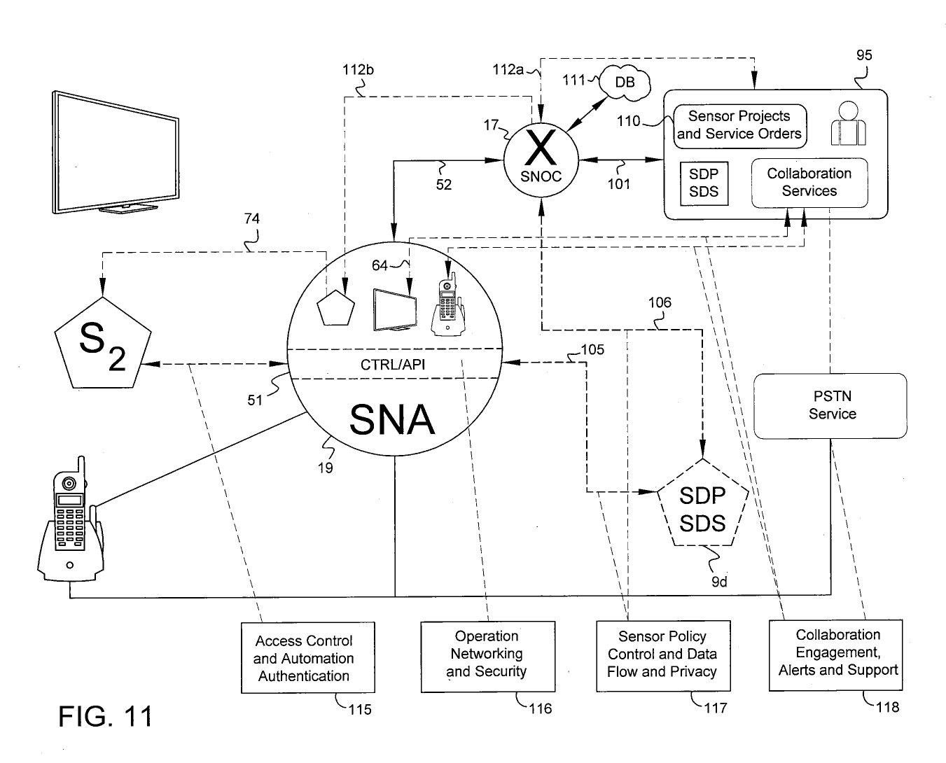

As shown in FIG. 11 an embodiment of the present disclosure implements flow-through integration capability regarding the exchange of service operation and control data, termed Service Policies. Service Policies, as used herein, are information templates related to provisioning and operation of services. Templates facilitate scalable, automated remote deployment, activation, and operation of services, replacing local human intervention. Service Policies contain, among other things, information elements related to security and private collaboration overlays that allow the authentication of network access and communication services, e.g., trigger the automated exchange of secure messaging and alerts regarding specific events and services. Flow-through policy control is depicted as Flow-through Policy Provisioning.

FIG. 11 shows an embodiment having an enterprise Information Exchange Interface 101 spanned between the SNOC 17 Data and Message Exchange Function and the enterprise business process center 95, implementing an industry compliant data and message exchange model between the SNOC and the enterprise, for the purpose of exchanging Service Policies, as related to vertical business processes 110. The embedded SNOC Data and Message Exchange Function transforms and forwards service policy messages over interface 112a to/from the enterprise business process center 95 and may also interface with a SNOC Cloud Data Base 111 for storage and archive. The SNOC 17 control function relays over interface 112b Service Policies to the embedded CTRL/API layer 51 of the related SNA(s), such as SNA 19. The CTRL/API layer stores Service Policies and forwards related information to embedded Sensor and Service Control Apps via, for example, embedded Service Policy APIs 64. The related Sensor and Service Control Apps may optionally complete flow-through provisioning using the Service Policy Template information to manage attached devices, such as sensor s₂, and related services via connection 74.

Without implying any limitations to the applicable scope of the disclosure, several types of Service Policies are depicted in specific embodiments of FIG. 11, related to the operation of sensor-based remote monitoring and related collaboration services. These may include, in an embodiment, one or more of Access Control and Automation Authentication 115, Operation Networking and Security 116, Sensor Policy Control and Data Flow and Privacy 117, and Collaboration Engagement, Alerts, and Support 118. Many other applications of the disclosure can be envisioned across the variety of vertical industries and are contemplated herein.

One embodiment of the disclosure depicted in FIG. 11 refers to flow-through provisioning of Sensor Policies, which are Service Policies that govern deployment, operation, and data handling requirements of sensor-based remote monitoring processes, such as sensor access control 115, network and security operation 116, sensor data handling and privacy policies 117, and sensor data triggered alerts 118, as may be relevant across a variety of vertical industries.

Another embodiment of the disclosure depicted in FIG. 11, refers to flow-through provisioning of Collaboration Policies, which are Service Policies that govern connection, operation, security and privacy restrictions for industry compliant collaboration, alerting and notification services, as may be relevant across a variety of vertical industries.

Third party SDP and/or SDS systems of sensor vendors 9d and interfaces 105 and 106 are as described above with respect to FIG. 10.

Policy-Based Service Automation

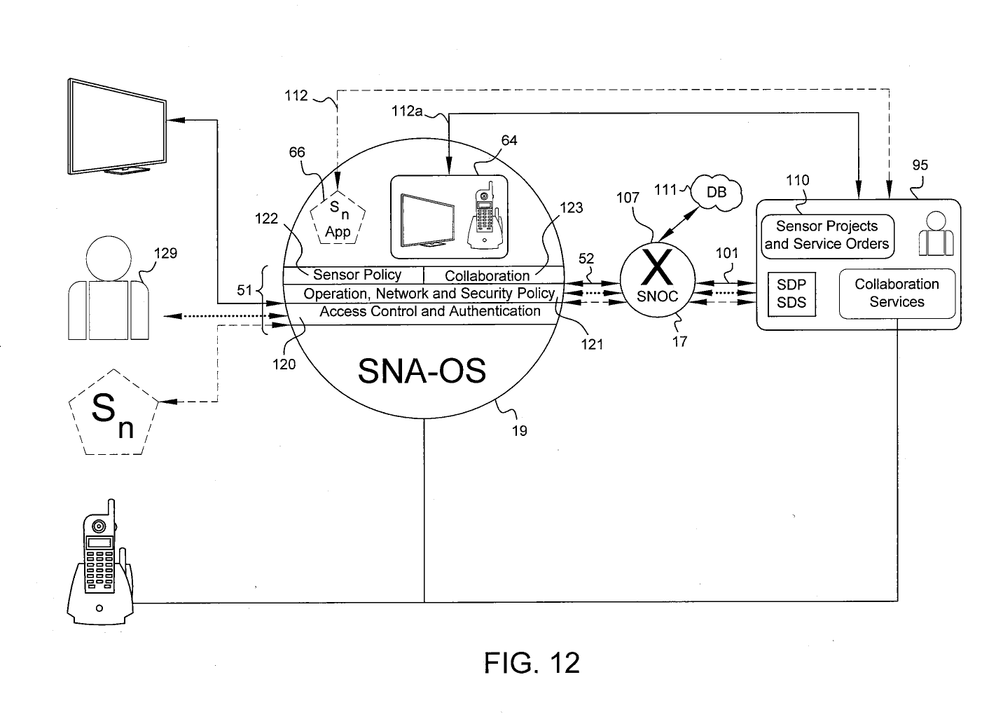

As shown in FIG. 12, an embodiment of the present disclosure implements flow-through policy integration to achieve remote service automation in respect to installation, activation, operation, and business process integration, of services deployed in a remote sensor network location. This is termed Policy-Based Service Automation.

FIG. 12 shows an enterprise Information Exchange Interface 101, spanned between the SNOC 17 Data and Message Exchange Function and the enterprise business process center 95, implementing an industry compliant data and message exchange model between the SNOC and the enterprise, for the purpose of exchanging Service Policies, as related to vertical business processes 110. The embedded SNOC 17 Data and Message Exchange Function may transform and/or forward Service Policy messages to the SNOC Cloud Data Base 111 for storage. The SNOC control function may relay one or more of these Service Policies to the embedded CTRL/API layer 51 of one or more related SNA(s), such as SNA 19, via secure transport layer protocol 52. It is contemplated, for example, that the SNOC may send a first Service Policy to a first SNA and a second Service Policy to a second SNA. The CTRL/API layer 51 may store Service Policies and forward application information to Sensor and/or Service Control Apps 66 and/or 64 via embedded APIs.

In an embodiment, the CTRL/API layer 51 may include two sub-layers, e.g., a Access Control and Authentication 120 layer and an Operations, Network and Security layer 121. The Access Control and Authentication 120 layer manages wireless and wired device access according to the related control policies/parameters 115 in FIG. 11 which may include device authentication and access control of wirelessly attached sensors, e.g., sensor sₙ, optional authentication and access control related to locally connected personnel 129, and/or the control of multi-media channels attached to the SNA in the context of collaboration service policies, as described above. In an embodiment, the Access Control and Authentication 120 layer may use open and/or global standards based service interface drivers of the SNA operating system.

The Operations, Network and Security layer 121 governs the operation of all centrally managed SNA sub-systems, including the highly secure and encrypted transport and messaging interface 52 to the SNOC 17, according to related control policies/parameters 116 in FIG. 11. The Operations, Network and Security layer 121 also manages and secures other data and collaboration network channels while protecting the SNA 19 from unauthorized access.

Without implying limitations to the applicability and/or scope of the present disclosure, two specific Service Policy APIs are depicted in FIG. 12 which are related to operation of sensor based remote monitoring 122 and embedded collaboration services 123, and may be in the context of service specific control policies/parameters 117 and 118 in FIG. 11, respectively. As will be apparent to one of skill in the art, many other applications of the disclosure can be envisioned across the variety of vertical industries.

Example for a Wireless Sensor Service Policy Template

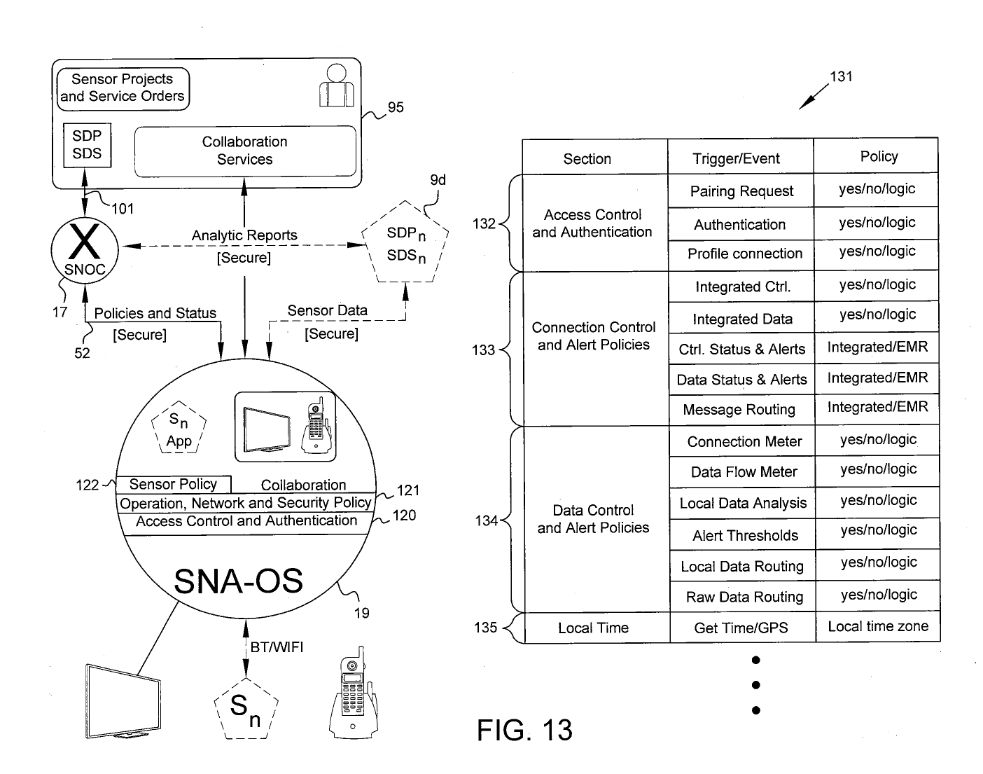

Without implying limitations to the applicability and/or scope of the present disclosure, FIG. 13 shows an embodiment for a Service Policy Template describing various layers of a Wireless Sensor Service.

The embodiment in FIG. 13 depicts the general message and data flow environment for a sensor-based remote monitoring service. Provisioning and status messages are exchanged using the highly secure transport and message interface 52 between SNOC 17 and the SNA 19 embedded Operations, Network and Security layer 121. The service is managed by the SNOC 17 and is connected to an enterprise business process center 95, using flow-through provisioning of Sensor Policies.

Without implying limitations to the applicability of the present disclosure, the embodiment in FIG. 13 presents an example for a Wireless Sensor Service Policy Template 131. As a specific embodiment of the disclosure, the depicted template 131 is neither intended to be complete, nor to be accurate in detail, as it serves simply to explain policy based service management functions offered by the present disclosure in the context of a remote monitoring service using SNA-attached wireless sensors. One of skill in the art will be able to envision many other applications of the present disclosure across a variety of vertical industries.

The Access Control & Authentication layer 120 in FIG. 13 enforces sensor related Access Control and Authentication Policies 132, as received by the SNOC 17, using open and standards based wireless sensor access protocols. This will be discussed in more detail further below.

The Operations, Network and Security layer 121 in FIG. 13 enforces Connection Control and Alert Policies 133, as received by the SNOC 17 using open and standards based networking and security protocols to enforce system security and information integrity. Connection Control and Alert Policies may typically govern routing and security of related connection and status messages, directly exchanged between the SNA 19 and the SNOC 17. This will be discussed in more detail further below.

The Sensor Policy API layer 122 depicted in FIG. 13 enforces sensor data related Data Control and Alert Policies 134, as received by the SNOC 17. Data Control and Alert Policies govern local sensor data analysis and alert generation services, as well as related status messages, exchanged between the SNA 19 embedded Sensor Policy API layer 122, the SNOC 17, as well as an optional 3rd party SDS/SDP subsystem 9d, associated with the raw data flow from the sensor sₙ. This will be discussed in more detail further below.

Data Control and Alert Policies 134 may also govern service provisioning and message exchange between the 3rd party SDS/SDP subsystem 9d and the SNOC 17 for the purpose of, as an example, business process integration at the enterprise level, such as the exchange of analytic data reports. The 3rd party SDS/SDP subsystem 9d is granted use of the integrated Data and Message Exchange Function of SNOC 17 and its industry compliant, secure Information Exchange Interface 101 connectivity.

The Operations, Network and Security layer 121 in FIG. 13 may also enforce Time and Location Policies 135, as received by the SNOC 17, using open and standards based network time and location protocols, to enforce system synchronization with attached devices, as well as making adjustments according to local SNA time zones, as they may be varying across a cloud-based service network architecture. The Sensor Policy API layer 122 may forward resulting time and location information to embedded Sensor and Service Control Apps. This will be discussed in more detail further below.

The Policies discussed above are exemplary only and are not meant to be all-inclusive, as would be obvious to one of skill in the art.

Example for a Collaboration Service Policy Template

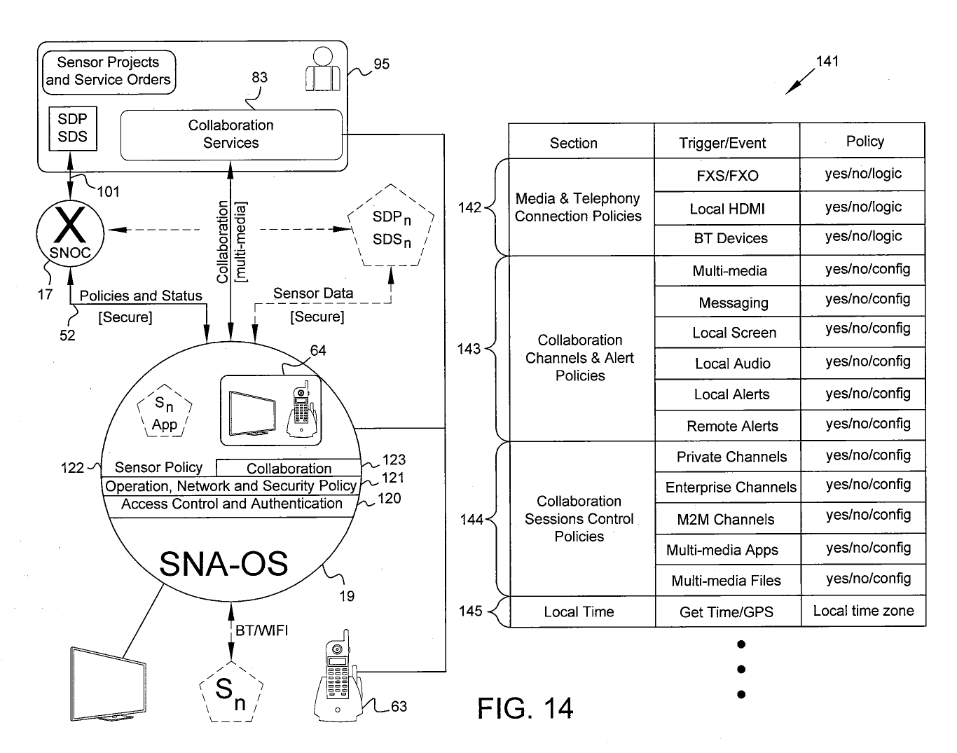

Without implying limitations to the applicability of the present disclosure, the embodiment in FIG. 14 shows an example for a Collaboration Service Policy Template 141 describing various exemplary layers of a remote collaboration service.

The embodiment in FIG. 14 depicts the general message, control and data flow for remote collaboration services. Provisioning and status messages are exchanged using the highly secure transport and message interface 52 between SNOC 17 and the SNA 19 embedded Operations, Network and Security layer 121. The service is managed by the SNOC 19, connected to the enterprise business center 95, for flow-through provisioning of Collaboration Policies.

Without implying limitations to the applicability of the present disclosure, the embodiment in FIG. 14 presents an example for a Collaboration Service Policy Template 141. In a specific embodiment of the disclosure, the depicted template 141 is neither intended to be complete, nor to be accurate in every detail, as it serves merely to explain policy-based service management functions offered by the present disclosure in the context of enterprise collaboration services, using SNA-attached communication devices. One of skill in the art will readily understand that any other applications of the present disclosure can be envisioned across a variety of vertical industries.

The SNA 19 embedded Access Control & Authentication layer 120 in FIG. 14 enforces Media and Telephony Connection Policies 142, as received by the SNOC 17, that govern physical connections used by SNA attached devices, and their association with logical channels used by, e.g., Collaboration Service Control Apps 64 in conjunction with centralized telephony 63 and collaboration services 83. This will be discussed in more detail further below.

The SNA 19 embedded Operations, Network and Security layer 121 depicted in FIG. 14 enforces Collaboration Channels & Alert Policies 143, as received by the SNOC 17, using open and standards based networking and security protocols to enforce system security and information and communication privacy. Collaboration Channels & Alert Policies 143 govern routing and security of related service channels, channel control, and status messages as exchanged between the embedded Collaboration Service Control API layer 123, the SNOC 17, and centralized collaboration services 83. This will be discussed in more detail further below.

The SNA 19 embedded Collaboration Policy API layer 123 depicted in FIG. 14 enforces Collaboration Sessions Control Policies 144, as received by the SNOC 17. Collaboration Sessions Control Policies 144 manage local multi-media services, as well as authenticated collaboration sessions between participants within and external to the enterprise. Collaboration Sessions Control Policies 144 can be used, for example, by multiple embedded Collaboration Service Control App 64. This will be discussed in more detail further below.

The Operations, Network and Security layer 121 in FIG. 14 also enforces Time and Location Policies 145, as received by the SNOC 17, using open and standards based network time and location protocols, to enforce system synchronization with attached devices, as well as making adjustments according to local SNA time zones, as they may be varying across a cloud-based service network architecture. The Collaboration Policy API layer 123 forwards resulting time and location information to, for example, embedded Collaboration Service Control App 64. This will be discussed in more detail further below.

The Policies discussed above are exemplary only and are not meant to be all-inclusive, as would be obvious to one of skill in the art.

Health Care Framework

A non-limiting, exemplary embodiment of the previously-presented general enterprise services framework is discussed in this section. However, in this section the general market framework assumptions shall be replaced by specific vertical requirements, as applicable to the health care vertical market, and specifically related to the standards and regulatory health care IT (“HIT”) framework.

This section is a non-limiting exemplary embodiment of the present disclosure, and it is not intended to reflect any limitation of the present disclosure regarding its application in other vertical markets. This section applies functional capabilities embedded in the present disclosure, as described in a more general framework in previous paragraphs. All previous explanations apply to this section, where not explicitly defined or amended in this section.

Prescriptive and Collaboration Services in the Health Care Market

As depicted in the embodiment shown in FIG. 15, the targeted health care solution allows integrated delivery of Prescription (Rx) based remote care, telecollaboration, and patient monitoring services, among other services.

The embodiment shown in FIG. 15 refers back to many of the previously-discussed concepts and definitions while also replacing the more general enterprise framework with specific terminology, technologies, subsystems, and protocols, as may be required in the regulatory and standards framework of the health care market.

The term Prescription (Rx) stands for a medical, provider-generated, electronic service order, transmitted to the SNOC 17 via standard HIT protocols, typically based on the Health IT Layer 7 (HL7) standard.

Without implying limitations to the applicability of the present disclosure, a typical service location is outside of a care providers' primary or hospital facilities, e.g., in a private home, apartment, managed care apartment, or a nursing home.

Installation, deployment, and remote service operation are integrated with standard prescription delivery processes. Government policies stipulate the use of Electronic Medical Record (EMR) systems 151 resulting in an automated flow-through service ordering paradigm. EMR systems 151 are typically used to manage patient population identities, as well as a patients' prescriptions, doctor visits, hospital visits, and other functions of the medical service delivery process. Existing ordering sub-systems of any EMR vendor issue HL7-based prescriptions for medication, education, training or laboratory services, amongst others.

EMR systems 151 also offer SDS and SDP functionality, recording and analyzing one or multiple instances of laboratory results, vital data measurements, and other data related to the diagnostic information base of a given patient. Alternatively, SDS/SDP functionality may be provided via third party provider(s) 9d via interfaces 105 and 106 as discussed above. The diagnostic information base may contain highly condensed analytic data to facilitate fast access and effective diagnostic interpretation for clinicians and primary care physicians.

In an embodiment, each HIT provider maintains a highly regulated and secure multi-media collaboration infrastructure, typically based on enterprise grade, multi-media PBX systems. These system are used in telemedicine applications, typically between multiple providers/facilities. The system may be connected to the public telephony service (PSTN) 71 and may be used to contact patients.

In the context of remote monitoring services raw sensor data can be centrally collected in 3rd party SDS and SDP sub-systems 9d, e.g., as offered as part of the remote sensor service. This external sub-system 9d may be used to aggregate and store patients' raw sensor data to provide analytic functions. In context of medical and diagnostic services, the resulting high-quality analytical data reports can subsequently be provided to and used efficiently by clinicians and primary care physicians, especially when delivered as an integrated part of the patients' resident EMR information base.

Prescriptive Automation of an Episodal Care Path

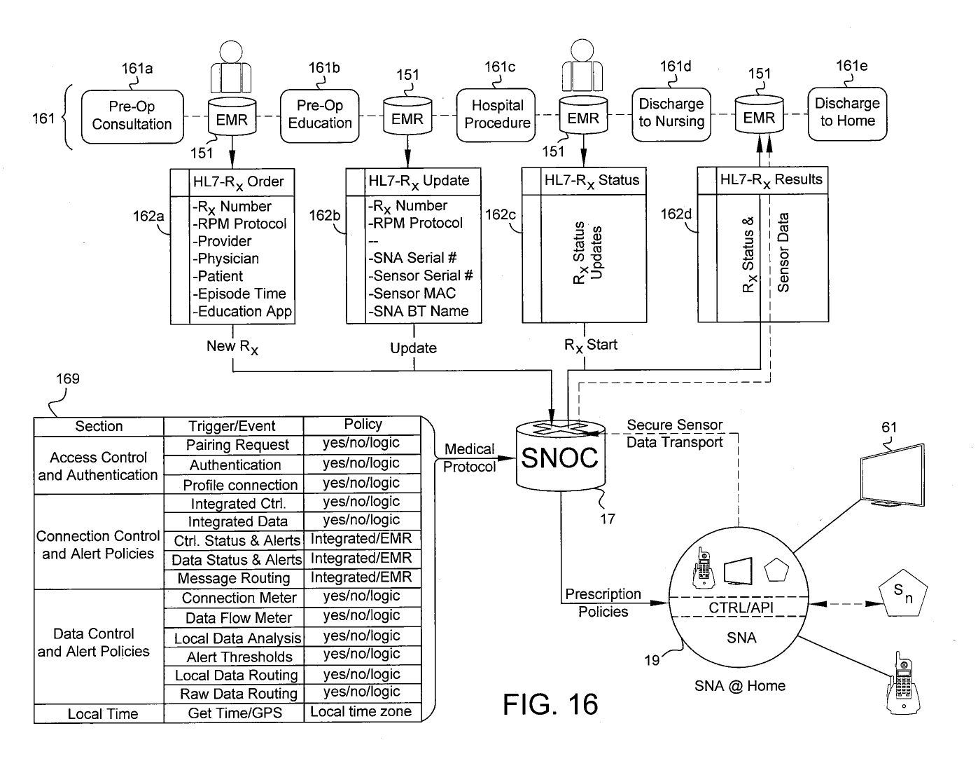

Without implying limitations to the applicability of the present disclosure, the embodiment in FIG. 16 shows one example of how flow-through policy provisioning can create fully automated delivery of a sensor-based remote patient monitoring project, integrated with standards based prescriptive delivery processes in the context of, for example, post-operative episodal care. There are virtually unlimited options, variations, and alternative embodiments of the process described in FIG. 16, needed to match the requirements of the many possible health care delivery processes, all of which are explicitly intended to be part of this disclosure, based on the principles and methods described herein.

The embodiment in FIG. 16 shows in row 161 a standard care path for an operational procedure. The patient care delivery process transits through a series of stages, 161a through 161e, as shown, during each of which a standard part of the prescription and care delivery process takes place. An end result is a remote patient monitoring (RPM) Prescription (Rx) solution that is automatically delivered and activated in a patients' home, which may be done without any patient interaction. The SNA 19, once installed at the patients' home, may automatically commence wireless pairing and connection establishment with the exact sensor(s) assembled for the prescription, based on policy information delivered to the SNOC 17 as part of the Rx-driven ordering process, and augmented with policy information added by the SNOC 17 from the definition of the specific Medical RPM Protocol. Aggregate policy flow-through provisioning of the SNA 19 enables fully automated RPM operation and policy driven data collection.

The present disclosure enables Prescriptive Automation through pre-definition of a repeatable medical and technology protocol, governing any deployment of a specific RPM protocol. This information is comprised of the Medical Protocol, or Care Plan associated with a specific RPM Protocol, as well as sensor specific equipment and configuration policies, augmented with generic wireless sensor service policies, as previously described in FIG. 13. The resulting Medical RPM Protocol information is assembled and stored as RPM Protocol Template 169—identified by a unique RPM Protocol Number, as shown in FIG. 16, which is shared between a provider's EMR 151 and the SNOC 17.

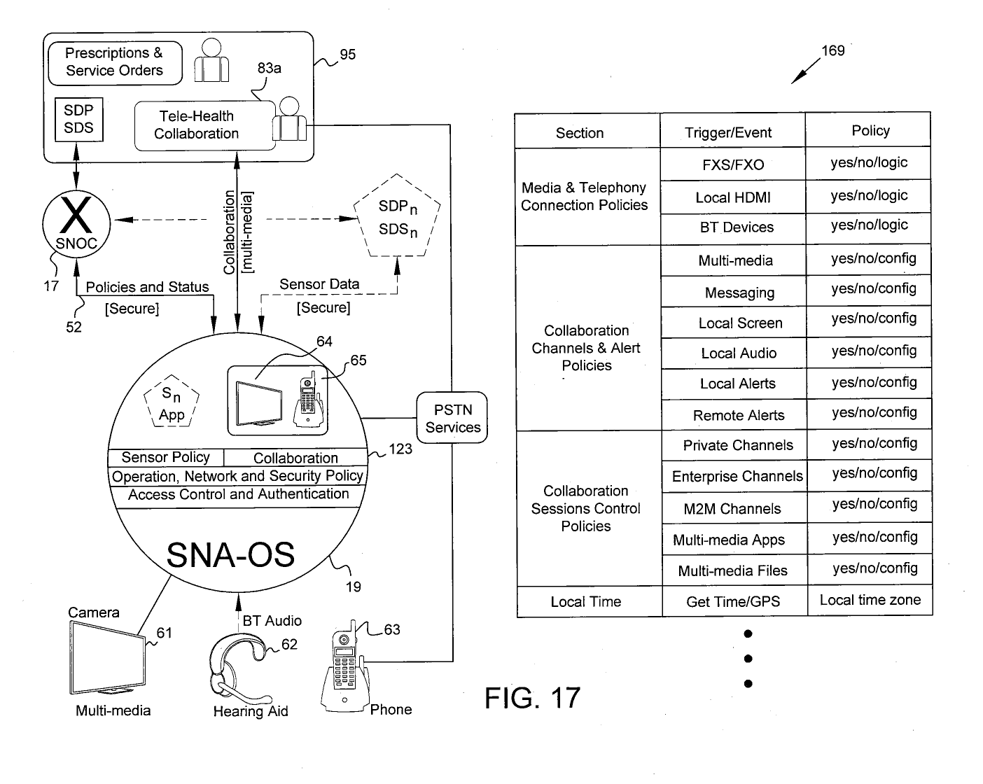

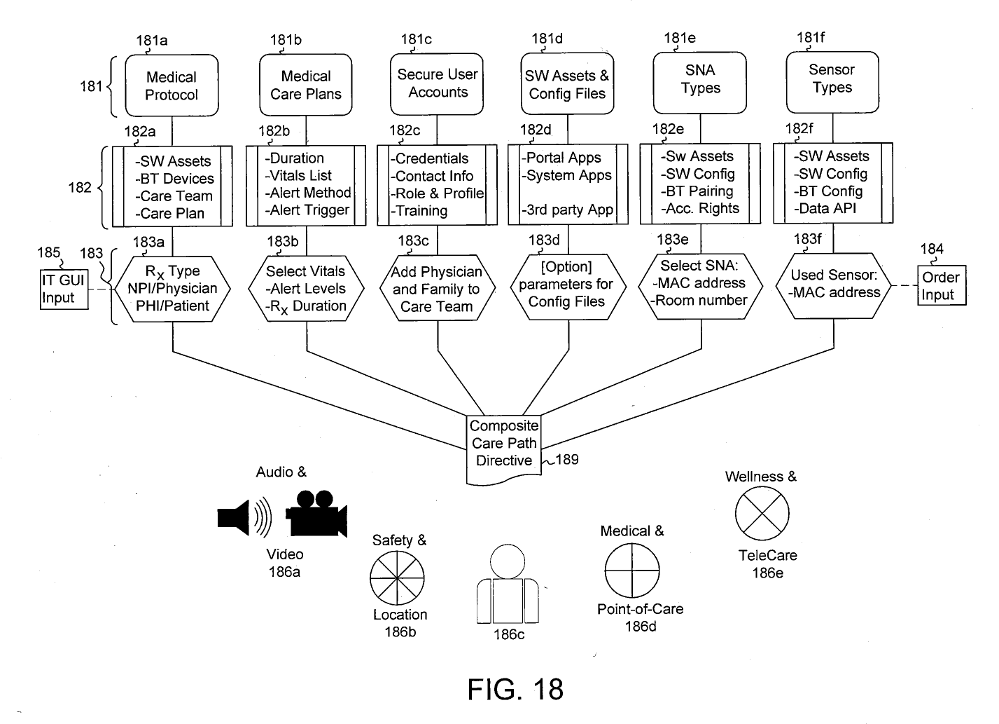

In an embodiment, initially, in the Pre-Op Consultation phase 161a, the patient sees the clinician at which time a decision is made to carry out a specific hospital procedure at a later time. At this point, the clinician enters the initial care path and planned procedure data into the EMR 151, including selection of the appropriate post-op RPM Protocol. This initial EMR entry results in an HL7 Rx Order 162a from the EMR 151 to the SNOC 17. The HL7 Rx Order 162a contains provider, patient, and medical protocol specific data, as shown in FIG. 16. The included RPM Protocol Number allows the SNOC 17 to identify the appropriate RPM Protocol Template 169, which contains all of the repeatable policy information, as described above. The SNOC 17 uses the received information, applies appropriate options from the medical protocol specific data, and creates a Rx-specific Care Path Directive 170, as shown in FIG. 18, from the associated Protocol Template 169, which contains all template and configuration information for remote installation, operation, alerting, and data reporting of the Rx Order 162a. Illustrative examples for embodiments of multiple care path related template operations are depicted in FIGS. 16 and 17, as described below. Additionally, FIG. 18 includes a more general description of a Care Path Directive.

As part of the Pre-Op phase 161a, the clinician may optionally prescribe Pre-Op Education 161b, e.g., in the form of an interactive or streaming video application. A related Education App can be pre-loaded on the SNOC as part of the RPM Protocol Template 169 and will be installed automatically on the SNA 19. This allows local display or interactive consumption of education material on the patient's TV screen 61 at home. Active patient participation can be captured and reported back to the EMR to prove compliance for related insurance payments.

In parallel to the preparation for the Hospital Procedure 161c, all ordered sensor and SNA equipment may be assembled for delivery to a nurse, for installation, patient training, and RPM test/operation in the hospital, or in a nursing home. The equipment may be scanned and inventoried in the EMR 151 ordering system for warranty and other legal reasons, which means that serial numbers and MAC address information are captured and can thus be electronically forwarded to the SNOC, e.g., in form of an HL7 Rx Update message 162b. This step completes the required technical information for the fully automated, policy controlled operation of any RPM Prescription by the associated SNA 19.

Explicit Legal Consent with authorization by the patient to carry out the RPM Prescription, including capture and storage of medical sensor data, as well as explicit authorization for optional involvement of home care personnel and family members, may also be provided. The related executed legal document and information is delivered to the SNOC 17 in the HL7 Rx Order 162a or an HL7 Rx Update message 162b, and must be archived by the SNOC 17 prior to first activation of the RPM equipment. In the event that alerts and alarms are to be issued to Care Team members the related HL7 message sequence must contain the required name and address information for such messages, e.g., email or mobile SMS addresses for private and secure message notifications.

In an embodiment, prior to Discharge 161d of the patient from, e.g., the hospital, or following admission to a nursing home, the delivered RPM equipment may be unpacked, connected, and installed by a nurse or other trained personnel, in order to verify readiness for (self-) installation in the home of the patient. Following the previous steps, the SNOC 17 may be pre-programmed to be ready to automatically recognize and pre-provision the SNA 19, as well as enabling the SNA 19 to automatically pair and connect all assembled sensors, e.g., sensor s₂. In this embodiment, the technical part of the initial RPM Prescription Activation is a fully automated process and easy to carry out by a nurse or other trained personnel. The EMR 151 is updated by the SNOC 17 regarding the successful activation of the RPM Prescription with an HL7 Rx Status message 162c.

At this time, the patient receives hands-on training pertaining to use and handling of the related sensor equipment, as well as the home installation of the SNA 19. Optionally, the RPM Prescription can remain active at this time, e.g., for data capture during a transitional stay at a skilled nursing home.

Following the SNA 19 installation in the home of the patient and the patient is discharged to home 161e, automated operation of the RPM Prescription commences as soon as sensors (e.g., sensor s₂) are in pairing mode. HL7 Rx Status messages 162d, triggered by events, as well as HL7 Rx Result messages 162d containing captured sensor data, are forwarded to the EMR 151 in accordance to the RPM Protocol Template 169, until the RPM Prescription Episode has elapsed.

At the end of the RPM Prescription Episode, the SNOC 17 may automatically unpair sensors (e.g., sensor s₂) and forces active operation of the RPM Prescription to cease. All data capture and forwarding to EMR 151 systems ends, and providers no longer receive pertinent medical information from the RPM equipment or service. The SNOC 17 may provide the provider with a final status report, capturing relevant events as logged and archived during the operational phase of the RPM Prescription Episode.

Integrated Telehealth Collaboration Services

Without implying limitations to the applicability of the present disclosure, the embodiment in FIG. 17 shows several examples for SNA-connected devices that facilitate automated Integrated Telehealth Collaboration Services 83a with, for example, patients or seniors under care at home.

The embodiment shown in FIG. 17 depicts several integrated, policy-driven telehealth solutions, comprised of SNA-attached multi-media 61, audio 62, and telephony equipment 63—integrated into the flow-through policy provisioning architecture described above. This solution allows automated alert and messaging services delivered to care staff, providers, and family members that have been authorized by the patient, e.g., as part of the patient consent process integrated with hospital procedures. The related prescriptive flow-through provisioning process allows the definition of the Policy Template 169, as depicted in FIG. 17. Auto-detection of authorized phone and multi-media connections, as well as prescribed wireless audio devices, such a hearing aids, allows SNA-embedded Collaboration Service Control Apps 123 to offer integrated and interactive Telehealth Collaboration services 83a, such as, but not limited to, virtual office visits, virtual home care visits, alert driven call-backs, emergency notification services, and many more.

The concurrent operation of authorized Sensor and Service Control Apps, e.g., 64 and 65, and Collaboration Service Control Apps 123 allows prescriptive control of a rich variety of integrated care paths, including home based patient education, interactive patient training, video and image streaming, and many more.

Importantly, following the authorization by the patient, e.g., by a senior citizen, fully automated video conferencing sessions, e.g., between family members, can be remotely [pre-]arranged and announced to the patient at home in real-time, e.g., with an automated phone call reminder—allowing hands-free participation of seniors in media rich collaboration and communication sessions.

Process Automation Using Composite Care Path Directives

Without implying limitations to the applicability of the present disclosure, the embodiment in FIG. 18 is an illustration of a concept of process automation through the use of templates 181 to build a composite Care Path Directive 189.

Automation as a result of the use of templates 181 allows the pre-definition or pre-allocation of all non-variant elements and assets that comprise a desired care path. Each of these templates may be complex templates themselves, thus being comprised of a variety of passive templates, application assets, configuration parameters, and each may be comprised of multiple execution options, to be defined as part of the prescriptive, electronic ordering, or manual activation process. Without limiting the general nature of the method, health care related care processes, as depicted in FIG. 18, may make use of several complex templates, used for automated integration of devices, applications, configurations, technical alerting thresholds, reporting templates, care plan parameters, care team lists, authorization rules, and many more, into the automated execution of a Care Path.

The templates 181 may include one or more of the following: Medical Protocol template 181a, Medical Care Plans template 181b, Secure User Accounts template 181c, Software Assets and Configuration Files template 181d, SNA Types template 181e, and Sensor Types template 181f.

In an embodiment, a Medical Protocol template 181a may include, for example, one or more of the items listed in block 182a such as, but not limited to, a list of Care Team members (e.g., doctors, nurses, therapists, etc.), a medical care plan to be applied, a sensor type to be used (e.g., blood pressure, thermometer, motion sensor, etc.), software assets to be downloaded, etc.

In an embodiment, a Medical Care Plans template 181b may include, for example, one or more of the items listed in block 182b such as, but not limited to, a default duration of a prescription, a list of individual vital measurements required to be taken, analytic logic and thresholds for real-time alerts, an alert method, etc.

In an embodiment, a Secure User Accounts template 181c may include, for example, one or more of the items listed in block 182c such as, but not limited to, user account information (e.g., name, identification, certification, etc.), user contact/communication data (e-mail address, phone number, SMS contact, etc.), a user account role (e.g., a type of generic user class), a user account profile (e.g., data, graphical user interface (GUI) and portal access, viewing rights, etc.), training information for system use, etc.

In an embodiment, a Software Assets and Configuration Files template 181d may include, for example, one or more of the items listed in block 182d such as, but not limited to, pre-loaded application files (e.g., system applications, portal applications, third party applications, etc.), etc.

In an embodiment, a SNA Types template 181e may include, for example, one or more of the items listed in block 182e such as, but not limited to, software assets that may be pre-loaded into any SNA when the SNA comes on line, software configuration information, sensor pairing information, access rights, etc.

In an embodiment, a Sensor Types template 181f may include, for example, one or more of the items listed in block 182f such as, but not limited to, software assets required for connected SNAs (e.g., for pairing and data exchange), Bluetooth pairing process description, software configuration information, data application program interface, etc.

Each of these templates may, as depicted in FIG. 18, optionally receive additional variable input parameters, e.g., as part of an electronic ordering or manual configuration process 184 and/or from a GUI input 185. These inputs may include, for example, one or more of the items listed in blocks 183 such as, but not limited to, a type of prescription, a physician's name, a patient's name (block 183a), a selection of vital measurements to be taken, alert levels for the vital measurements, a duration for the prescription (block 183b), a family physician and/or family member to be added to the Care Team (block 183c), parameters for configuration files (block 183d), a MAC address and/or room number or similar identifying information for an SNA (block 183e), a sensor type to be used and an associated MAC address (block 183f), etc.

As depicted in FIG. 18, a specific complex Care Path Directive is therefore the end result of one or more electronic ordering and/or manual configuration steps, centrally authenticated, registered, archived, and administered by a SNOC Admin Server (discussed in further detail below), selecting a specific set of pre-defined protocol templates and completing them with optional input parameters. The SNOC Administration Server may then install, activate, and/or operate all applications, devices, configurations, connections, and portals, securely controlled through the Ctrl & API layer (as described above) that extends between the SNOC and all SNA subsystems.

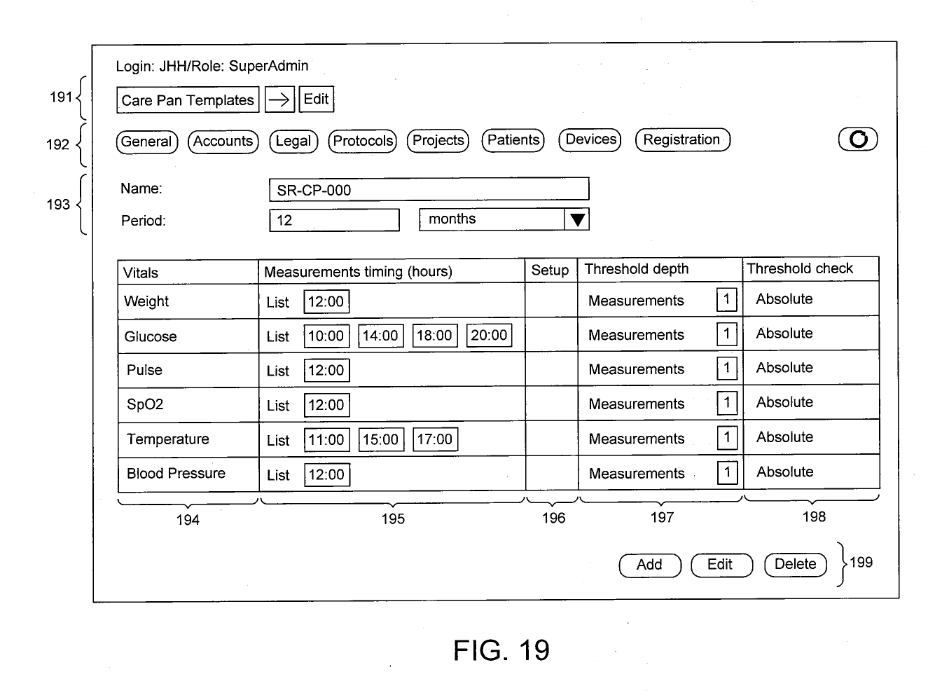

The SNOC can add, modify or delete any and all templates and the assets installed on SNAs under direction of a Care Path Directive, at any point in time, e.g., as prescriptions come to an end, or as new prescriptions are added to a patients' telecare service, as discussed with respect to FIG. 19. Thus, a Care Path Directive may include information related to, for example, audio and/or video information 186a, and/or safety and location information 186b, and/or patient information 186c, and/or medical and point-of-care information 186d, and/or wellness and telecare information 186e.

FIG. 19 is an example of an embodiment of a Medical Care Plan template 181b that can be edited using, for example, the GUI input 185. In this exemplary template, the type of template is shown at 191, a list of buttons for subscreens and/or additional information are shown at 192, the prescription name and duration are shown at 193, a list of vitals are shown at 194, a timing of the measurements of the vitals are shown at 195, setup information is shown at 196 (none shown in this exemplary embodiment), a threshold depth values are shown in 197 and threshold check values are shown in 198 (e.g., alert and alarm values for the measurements), and navigation/editing buttons are shown at 199.

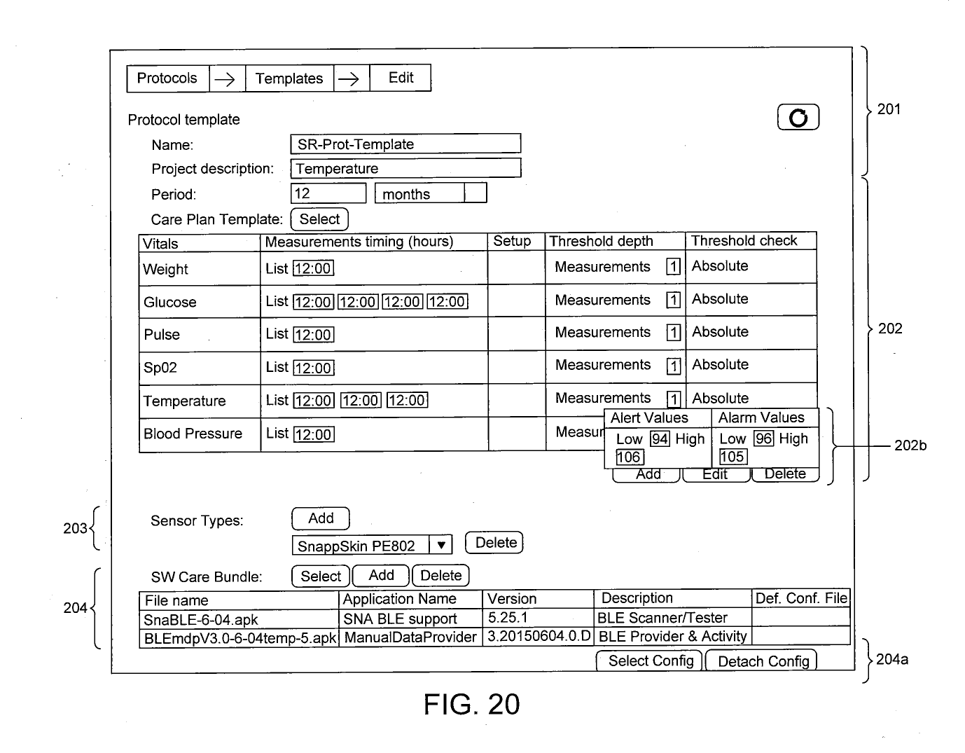

FIG. 20 is an example of an embodiment of a Medical Protocol template 181a that can be edited using, for example, the GUI input 185. In this exemplary template, a template description appears at 201 which may include the template name, a description, and a duration. At 202, a button 202a allows the selection and inputting of a Care Plan template such as the one shown in FIG. 19. The parameters that appear in the Care Plan template 202 may be adjusted in window 202b. At 203, sensor types may be listed and sensors may be added or deleted. At 204, software assets and associated information/configuration parameters may be listed and edited using the buttons 204a.

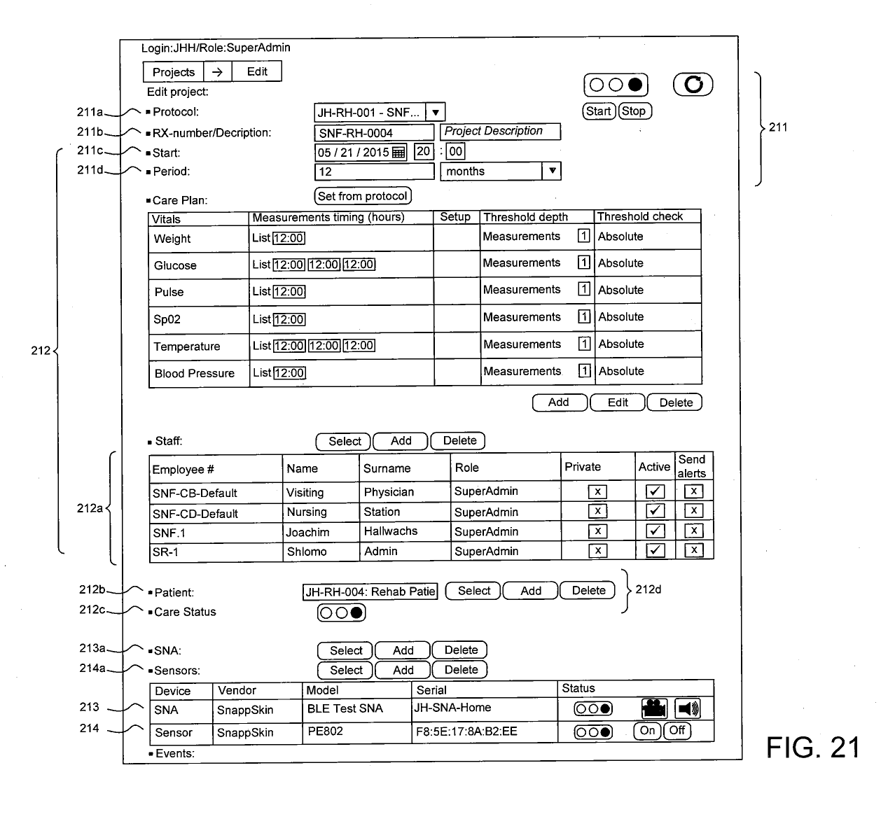

FIG. 21 is an example of an embodiment of a Care Path Directive 189 using input from the Medical Protocol template from FIG. 20. Section 211 includes information for the Care Path Directive including the Medical Protocol template number 211a, a prescription number and description 211b, a start date and/or time for the prescription 211c, and a duration for the prescription 211d. Section 212 includes input from the Medical Protocol template from FIG. 20 as well as Care Team Member information at 212a, patient information at 212b including a care status at 212c, edit buttons 212d, SNAs to be used at 213, sensors to be used at 214, and respective edit buttons 213a and 214a. Other information may also be included as described above.

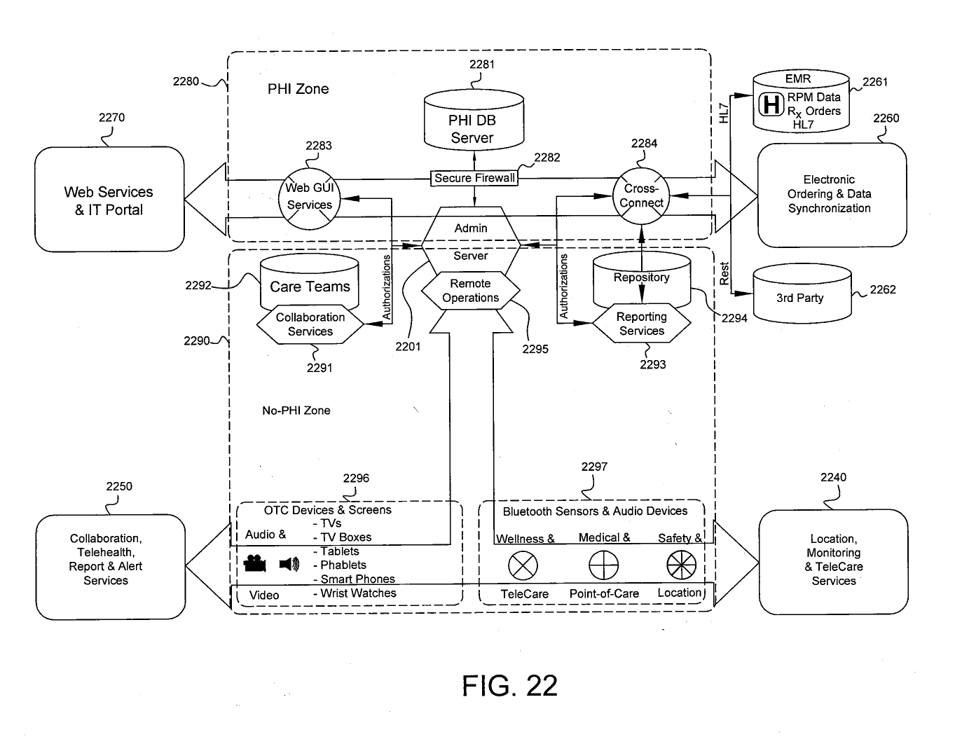

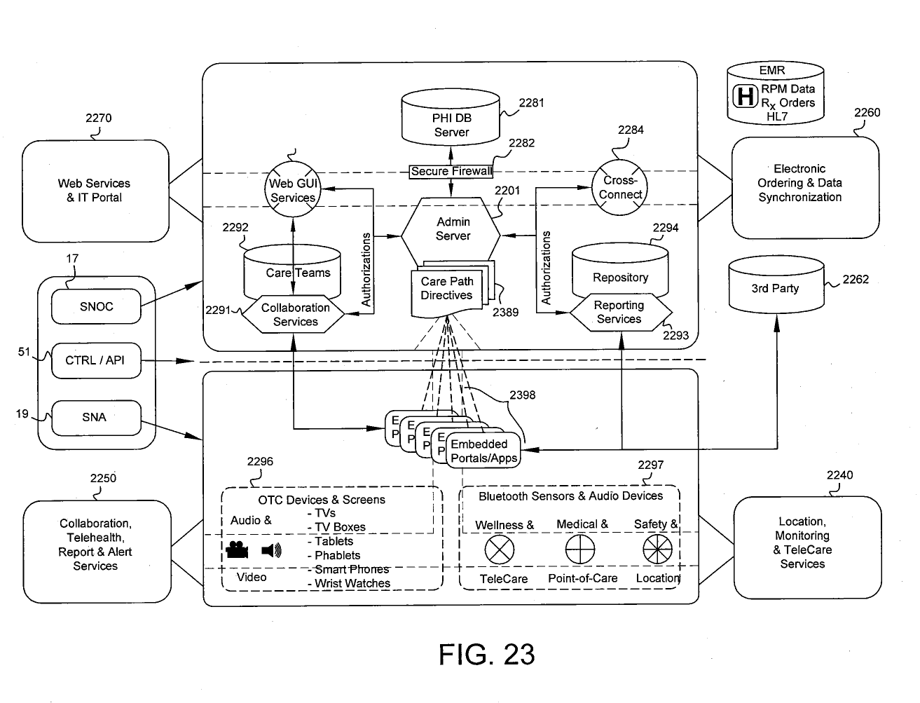

FIGS. 22 and 23 depict the SNOC subsystems/architecture of a specific embodiment of the disclosure, as applicable to an integrated tele-care, telehealth, and home safety solution.

In FIG. 22, SNOC administration (admin) server 2201 is part of the interface between the Protected Health Information (“PHI”) zone 2280 and the non-PHI zone 2290. The PHI zone 2280 includes a PHI Database Server 2281 which connects to the SNOC admin server 2201 via a firewall 2282. The SNOC admin server authorizes Web GUI services 2283 so that the SNOC admin server can communicate with web services and IT portal systems 2270. The SNOC admin server also authorizes Cross Connect/Cloud Connect 2284 so that the SNOC admin server can communicate with Electronic Ordering and Data Synchronization systems 2260, Electronic Medical Record (EMR) systems 2261 (as described above) typically via an HL7 link and third party systems 2262 (as described above) typically via a REST (Representational State Transfer) interface.

In the non-PHI zone 2290, the SNOC admin server 2201 authorizes Collaboration Server/Services 2291, such as a Care Team 2292 (as described above), so that the SNOC admin server can communicate with Collaboration Services 2291 in the non-PHI zone 2290. The SNOC admin server may authorize the connection of external web service clients to the Collaboration Services 2291 facilitating the use of open, web-based collaboration tools, such as webRTC, to interface with embedded collaboration clients on SNA subsystem 2296. The SNOC admin server 2201 also authorizes Reporting Services 2293 so that the SNOC admin server can communicate with Reporting Services 2293, which access data stored on the Data Repository Server 2294, in the non-PHI zone 2290. The SNOC admin server may authorize the exchange of data from the Repository 2294, with external SDS/SDP subsystems, such as authorized EMR or third party servers, using the Reporting Services 2293. This data exchange can, optionally, take place in the context of patient identifying PHI data, provided by the SNOC Admin server 2201 to authorized external data synchronization services 2260 via the secure Cross Connect 2284.

Also in the non-PHI zone 2290, the SNOC admin server 2201 executes Remote Operations services 2295 which may, in an embodiment, manage a variety of embedded over-the-counter (OTC) devices, such as mobile devices of many form factors and embedded devices that drive larger monitor of TV screens, such as TV boxes or set top boxes, etc., providing any or all of these embedded boxes with secure SNA and CTROL/API functionality, to thereby access Collaboration, Telehealth, Report, and Alert Services 2250 as described herein. The Remote Operations 2295 may further include, in an embodiment, the centralized operation and automation of SNA attached Bluetooth sensors and audio devices, as described herein, for Wellness and TeleCare, Medical and Point-of-Care, and Safety and Location services and systems, to thereby access Location, Monitoring, and TeleCare Services as described herein.

FIG. 23 is similar to FIG. 22 where the features with the same designation numbers in the two figures are the same. FIG. 23 shows an overlay of a SNOC 17, comprised of the various subsystem and sub-functions, as described above, as well as the CTRL/API layer 51, and an SNA 19 with the groupings of the various identified embedded functions and features, as well as attached sensors for each of these devices, as described above. Additionally, the SNOC 17 shows how the Admin Server 2201 is executing Care Path Directives 2389 thereby managing the deployment and operation of all embedded portals and Apps 2398 as an embedded function of SNA 19, controlled by the CTRL/API layer 51. Through the CTRL/API layer, the Admin Server 2201 authorizes, facilitates, and controls how the embedded portals and Apps 2398 can communicate with the Collaboration Services 2291, Reporting Services 2293, and/or third party SDS/SDP systems 2262, as shown.

A brief description of an embodiment of the subsystems of SNOC 17 shown in FIG. 23 are presented below. The SNOC admin server 2201 handles/provides system business logic, a centralized ordering interface (e.g., PHI registration functions, admissions), user security and authentication services (e.g., role/access profiles), centralized Care Path driven provisioning services for a multitude of, e.g., SNAs, Sensors, Apps, Templates, etc., centralized resource management and operation services (e.g., commands, responses, GUI operations, etc.), and centralized alert, alarm, and reporting administration services (e.g., thresholds, devices, status, etc.) The SNOC PHI Database Server 2281 handles/provides HIPAA (Health Insurance Portability and Accountability Act of 1996)-compliant PHI data storage that is typically encrypted and firewall-protected). The SNOC Collaboration Server 2291 handles/controls secure audio, video, and messaging services (e.g., typically for non-PHI functions/data, encrypted functions/data, and/or patient authorized functions/data). The SNOC Repository Server 2294 handles/provides non-PHI data storage (which typically cannot be accessed without explicit authorization and a token), centralized reporting services (typically requires Admin authorization to access), and non-PHI data export services (typically big data access and/or anonymous). The SNOC Cross Connect/Cloud Connect device 2284 receives/forwards HL7, XML, SOAP (Simple Object Access Protocol), and/or HTTPS cross-connect services, EMR/EHR (Electronic Medical Records/Electronic Health Records) registrations, ordering, result, and data exchange services.

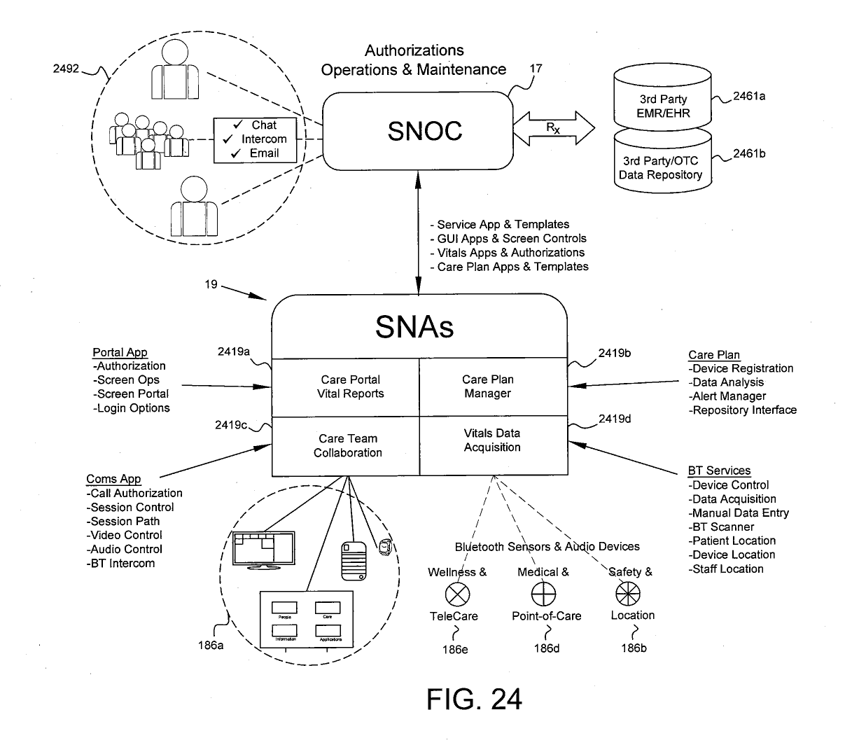

FIG. 24 illustrates an embodiment of the embedded portals/apps 2398 of SNA 19. In the embodiment shown, the SNOC 17 can communicate, e.g., for a prescription, with third party EMR/EHR 2461a and/or with a third party/over-the-counter data repository 2461b. The SNOC 17 may also communicate with, e.g., one or more Care Team members 2492. Also, the SNOC 17 can supply to the SNA 17 a variety of functionalities such as, but not limited to, service apps and templates, GUI apps and screen controls, vitals apps and authorizations, Care Plan apps and templates, etc. The exemplary SNA 19 may include Care Portal Vital Reports App 2419a, Care Plan Manager App 2419b, Care Team Collaboration App 2419c, and/or Vitals Data Acquisition App 2419d. The Care Portal Vital Reports App 2419a may provide a variety of functionalities such as, but not limited to, authorization, screen operations, screen portal functionality, and/or login options. The Care Plan Manager App 2419b may provide a variety of functionalities such as, but not limited to, device registration, data analysis, alert manager, and/or repository interface. The Care Team Collaboration App 2419c may be connected to one or more audio/video device 186a and may provide a variety of functionalities such as, but not limited to, call authorization, session control, session path, video control, audio control, and Bluetooth intercom. The Vitals Data Acquisition App 2419d may be connected to Wellness and TeleCare devices 186e, Medical and Point-of-Care devices 186d, and/or Safety and Location devices 186b and may provide a variety of functionalities such as, but not limited to, device control, data acquisition, manual data entry, a Bluetooth scanner, patient location, device location, and/or staff location.

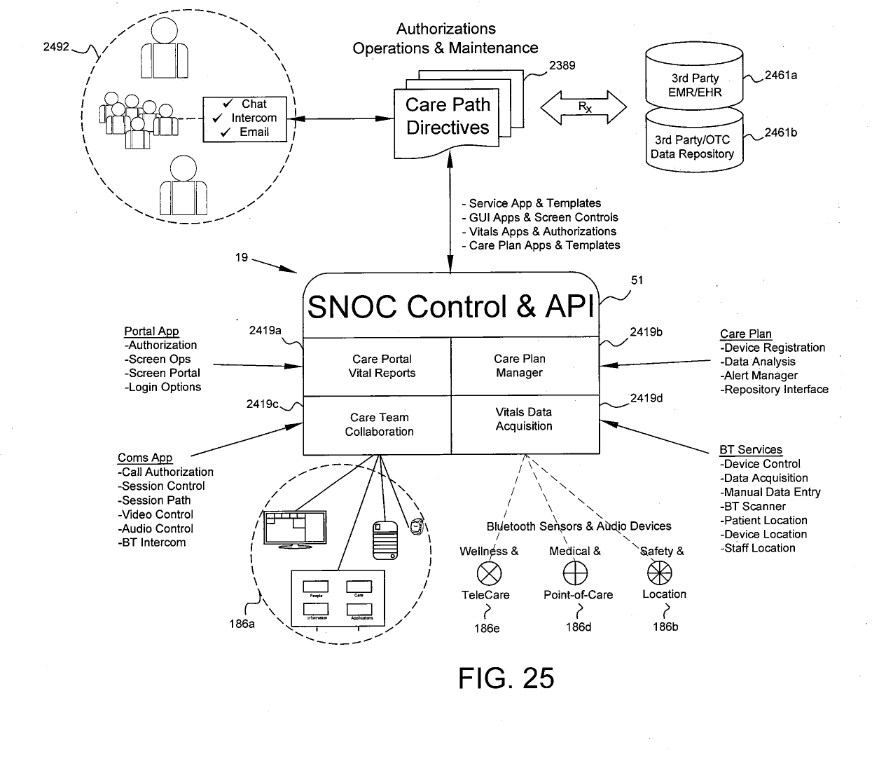

FIG. 25 is similar to FIG. 24 where the features with the same designation numbers in the two figures are the same. The embodiment depicted in FIG. 25 shows Care Path Directives 2389 being provided to the SNOC Control and API layer 51 of SNA 19 where the Care Path Directives 2389 provide information/directives for the applications and functionalities shown, as discussed above.

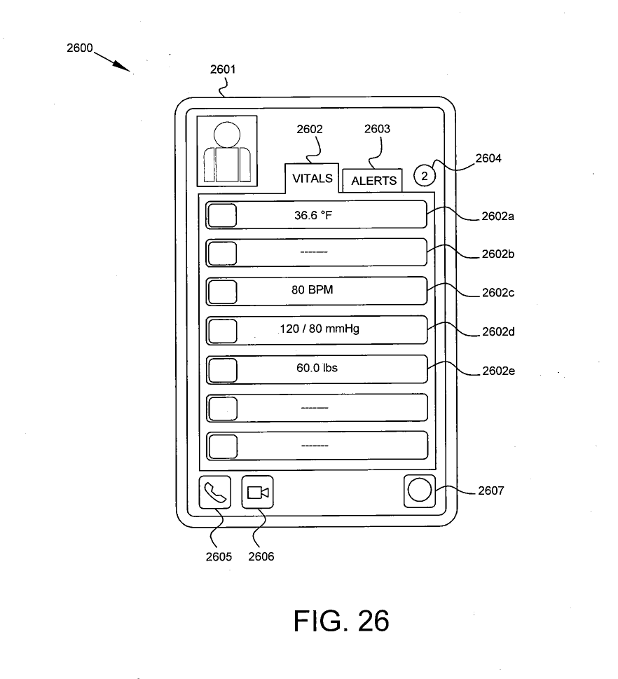

FIG. 26 depicts a non-limiting, exemplary Mobile Care Board 2600 that may be an application that can be displayed on a patient's mobile computing device 2601 (e.g., smart phone, tablet, smart watch, etc.) as well as on a larger device (television screen, laptop computer screen, desktop computer screen, etc.) In the embodiment shown, the Mobile Care Board may display a picture of the patient as well as the patient's location, and may include screens for a Vitals Portal (as shown, this portal is active) 2602 and an Alerts Portal (tab shown) 2603 (other portals as described herein may also be displayed depending on the situation), an Alert Status indicator 2604 (for both medical alerts and technical alerts), an embedded intercom icon 2605, an embedded video icon 2606, and an embedded messages pending icon 2607. Typically, the icons can be accessed regardless of which portal is active.

Non-limiting examples of the types of information that are available on the Vitals Portal include temperature 2602a; a display of information from continuous monitors 2602b (e.g., wearable devices) where the information displayed may be auto-synched with data storage devices/data repositories, time-stamped, include histograms (e.g., hourly/daily/weekly trends), access to a Reports Portal, etc.; heart rate 2602c, blood pressure 2602d, patient's weight 2602e, and other information as described herein. The vitals measurements may include information pertaining to patient recognition, device recognition, the type of connection used by the device, alert generation and the ability to refresh the view manually and/or automatically.

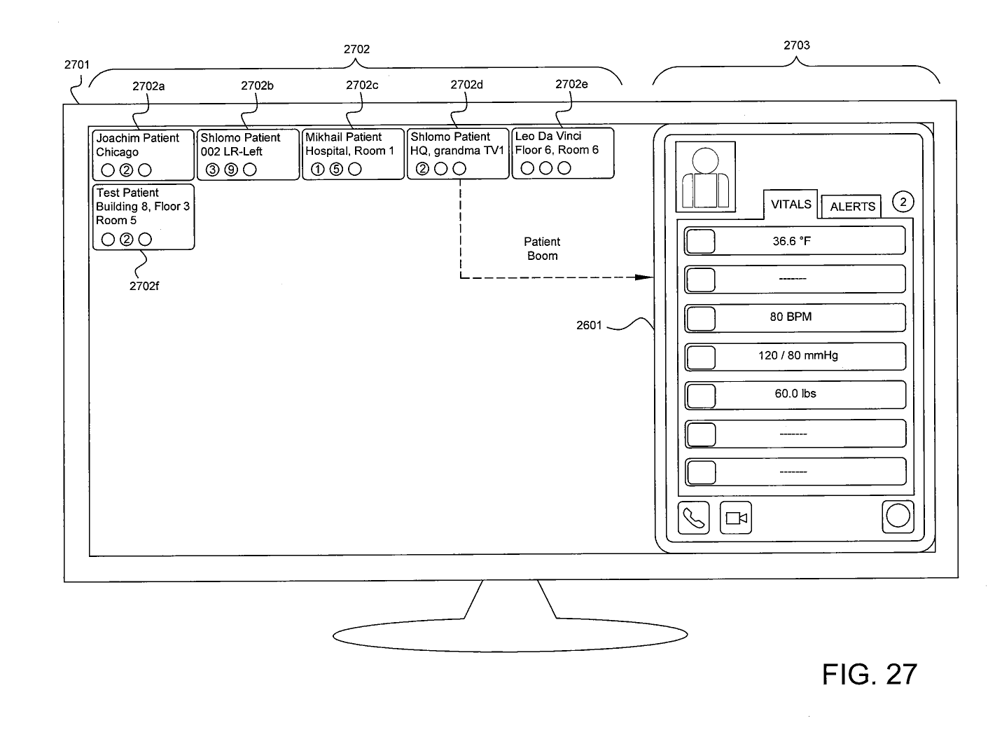

FIG. 27 illustrates an embodiment of a monitor screen at a central care desk 2701 such as may be situated at a nursing station or other central care location. The central care desk screen may include two sections, such as a patient population view 2702 and a patient view 2703. The patient population view may include icons 2702a-2702f typically for patients under active care such as, but not limited to, patients on a rehabilitation floor, under home care, out patients, referred patients, and patients undergoing therapy/recovery. Typically these patients have an active prescription operating through the system as described herein. In the patient population view 2702, the patient icons may be organized in a number of ways, such as, but not limited to, a physical location (building, floor, room, geographic area, etc.), type of prescription in the system, type of medical procedure or recovery/therapy, insurance type, technical set-up, type and/or status of alerts, etc.

FIG. 27 shows patient icon 2702d having been selected by a care desk operator and the corresponding patient information 2601 being displayed in the patient view section 2703. In an embodiment, the patient information 2601 may be as described above in FIG. 26.

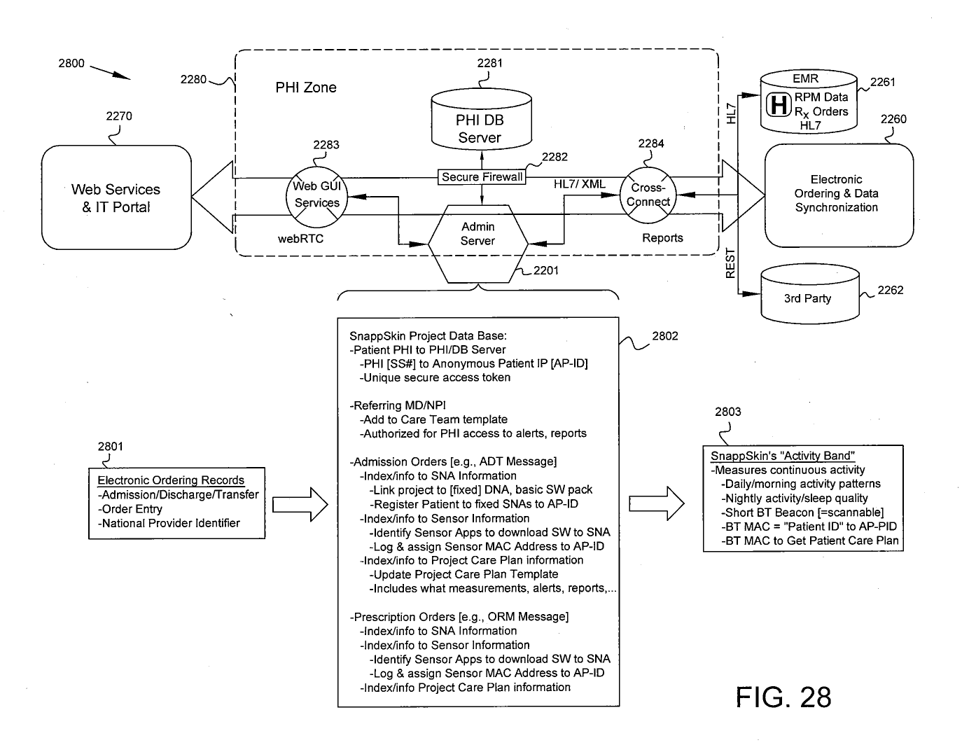

FIG. 28 is an illustration of a process flow according to an embodiment of the present subject matter. In an embodiment, system 2800 may include the devices and connections shown, which are described above with respect to at least FIGS. 22 and 23. Block 2801 includes exemplary electronic ordering record messages which may include a message generated from EMR (Electronic Medical Records), an HL7 (Health Level 7) message such as an admission, discharge, transfer (“ADT”) message, an HL7 message such as an order entry (“ORM”) message, or any other electronic order message. These exemplary electronic ordering record messages may include information such as: a referring physician name and/or NPI (National Provider Identifier), a patient's Protected Health Information (“PHI”) and/or social security number, an electronic prescription (as described herein) and/or information regarding an admission type (which may be indexed into a Protocol Template), Care Plan parameters (which may update a project's current Care Plan), and device parameters (which may update a current project's Device Template).

Block 2802 indicates, for an embodiment, information that may be processed and/or routed to/from the Admin Server. Patient PHI may be sent to the PHI DB server 2201 and/or an anonymous patient identifier (“AP-ID”) may be assigned for sending/accessing patient PHI to/from a third party database 2262. Also, a secure access token may be assigned to the patient PHI for either the PHI DB server or the third party database 2262. The referring physician information may be added to a Care Team template and the referring physician may be authorized to access the patient's PHI as well as receive alerts and reports from the system.

An admission order, e.g., an ADT (Admission, Discharge, Transfer) message, may provide or initiate an index or information to be sent to an SNA. This information may include a link to an SNA, an identification of software for the SNA, and may register the patient with the SNA and/or a third party database 2262 with an AP-ID. Also, the admission order may provide or initiate an index or information to a sensor, such as an identification and/or downloading of a sensor app to the SNA. Additionally, the admission order may provide or initiate an index or information to log and/or assign a MAC address for the sensor and/or a third party database 2262 with an AP-ID. The admission order may provide or initiate an index or information to log and/or assign an update to a current project Care Plan Template and may include information regarding required measurements, alerts, and reports.

A Prescription Order (e.g., an ORM (Order Entry Message)) may provide or initiate an index or information to be sent to an SNA or sent to a sensor. This may include downloading of a sensor app to the SNA, information to log and/or assign a MAC address for the sensor and/or a third party database 2262 with an AP-ID, and/or assigning an update to a current project Care Plan Template.

In Block 2803 shows, for an embodiment, an Activity Band that may be used with the described system as a sensor. The Activity Band is typically, but not limited to, a low-cost, disposable, lightweight, waterproof, easy-to-wear, battery-operated device that includes Bluetooth functionality for connection to an SNA. The Activity Band typically is used for measuring continuous activity (i.e., it may be a motion sensor) such as, but not limited to, activity patterns over a configurable block of time (e.g., hourly, daily, morning, nightly, etc.) and may be used to monitor sleep quality. The Activity Band may also provide a patient identifier and may be configured to measure activity according to a Patient Care Plan.

In an embodiment, electronic prescriptions/Service Orders may include information such as: Template selection for a related system project, medical sensor, collaboration, and/or Care Plan, a patient admission order to any service package such as provisioning an Activity Band where, e.g., an electronic (manual) order may automatically trigger remote installation of all related Bluetooth and Portal apps and where an ordering record may contain information regarding a sensor type, a MAC address, and/or a serial number and PHI of the admitted patient. Additionally, the electronic prescriptions/Service Orders may include information for the Activity Band such as short periodic advertisements and can also advertise sensor type/info and MAC address of the Activity Band. Furthermore, the electronic prescriptions/Service Orders may contain an Operational and Data Aggregation Template and may positively link the Activity Band to the Anonymous Patient ID (AP-ID) derived from PHI, which may be used by vault and repository services/databases for legal data access.

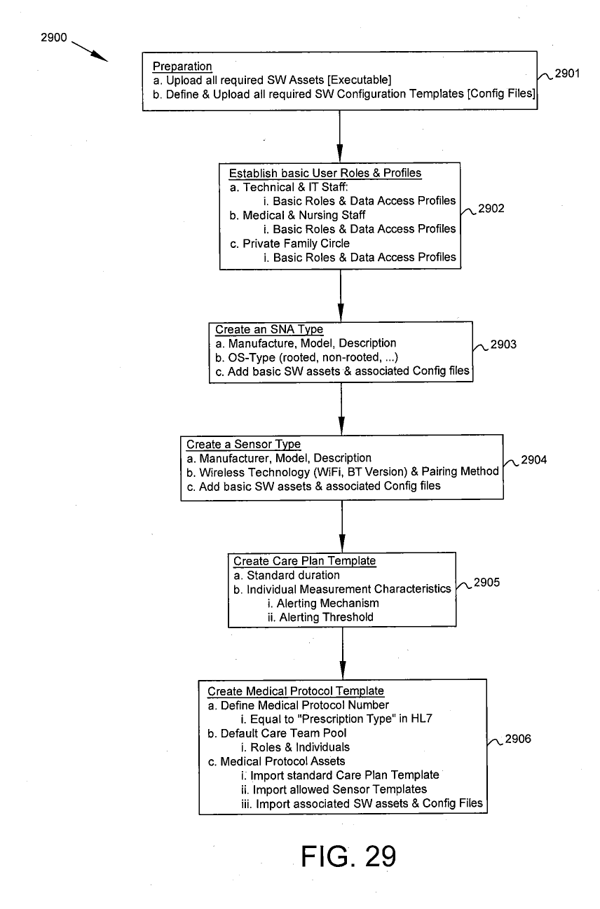

FIG. 29 is a flow chart 2900 of a manually-entered process flow for creating Templates according to an embodiment of the present subject matter. The information to be input in blocks 2901-2906 for creating Templates may be entered using, for example input entered via the IT GUI 185 in FIG. 18. At block 2901, all required software assets (e.g., executable files) may be uploaded. Additionally, all required software configuration templates (e.g., config files) may be defined and uploaded. At block 2902, basic user roles and data access profiles may be established (e.g., technical and IT staff, medical and nursing staff, private family circle, etc.) At block 2903, an SNA type may be created/assigned which typically includes identifying the manufacturer, model, a description of the SNA, and the operating system type. Appropriate basic software assets (e.g., executable files) and associated config files from block 2901 may be added to the SNA. At block 2904, a sensor type may be created/assigned which typically includes identifying the manufacturer, model, a description of the sensor, the wired or wireless technology to be used for connecting the sensor to the SNA, and the pairing method for connecting the sensor to the SNA. Appropriate basic software assets (e.g., executable files) and associated config files from block 2901 may be added to the sensor.

At block 2905, a Care Plan Template may be created, for example, the Care Plan Template shown in FIG. 19. A duration for the treatment/electronic prescription may be entered and individual measurements and measurement characteristics may also be entered (e.g., alerting mechanisms, alerting thresholds, etc.) At block 2906, a Medical Protocol Template may be created, for example, the Medical Protocol Template shown in FIG. 20. This may include, for example, defining a medical protocol number (which may be the same as a “Prescription Type” in HL7), defining the default Care Team pool (e.g., identifying individuals in the Care Team and their roles), and defining Medical Protocol assets, by, for example, importing information from a Care Plan Template, importing information from a created/assigned sensor, and importing all associated software assets and config files.

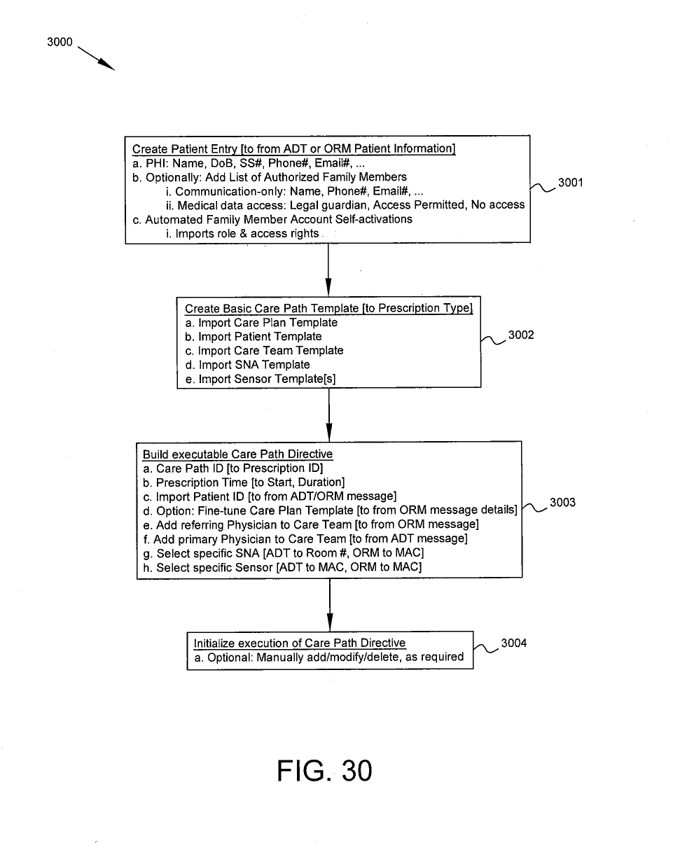

FIG. 30 is a flow chart 3000 of an automatically-entered process flow for initializing a Care Path Directive, such as, for example, the Care Path Directive shown in FIG. 21, according to an embodiment of the present subject matter. In an embodiment, the steps in flow chart 3000 may follow the steps in flow chart 2900 in FIG. 29. The information to be input in blocks 3001-3004 for creating a Care Path Directive may be entered automatically and/or manually using, for example input entered via the IT GUI 185 in FIG. 18. At block 3001, a patient entry may be created, the information for which may be obtained automatically from an ADT message or from patient information in an ORM. The patient entry information typically includes PHI information. The patient entry information may also include a list of authorized family members, some of which may receive communications only and others of which may have medical data access, as well as information regarding roles and access rights. At block 3002, a Care Path Template (e.g., a Prescription Type) may be created by importing, automatically or manually, information from, e.g., a Care Plan Template, a Patient Template, a Care Team Template, an SNA Template, and Sensor Template(s). Any one or more of these Templates may be created as discussed herein and/or from a process using appropriate steps from FIG. 29.

At block 3003, an executable Care Path Directive may be created. This may include, for example, information such as a Care Path ID (which may be the Prescription ID), a prescription time (e.g., start time and duration), the patient ID (e.g., from an ADT/ORM message), a Care Plan Template (which may be fine-tuned, if desired), a Care Team Template (to which information such as the referring physician and/or a primary physician may be added), a specific SNA selection (e.g., may be a room number if from an ADT or a MAC address if from an ORM), and a specific sensor or set of sensors (e.g., may be a MAC address if from an ADT of ORM). At block 3004, the Care Path Directive may be initialized and/or executed. Manual modifications to the information in the Care Path Directive may be entered as required.

While this specification contains many specifics, these should not be construed as limitations on the scope of the claimed subject matter, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

While some embodiments of the present subject matter have been described, it is to be understood that the embodiments described are illustrative only and that the scope of the disclosure is to be defined solely by the appended claims when accorded a full range of equivalence, many variations and modifications naturally occurring to those of skill in the art from a perusal hereof.

I claim:

1. A method for a health care provisioning protocol, the method comprising the steps of:
(a) receiving at a server a first input for a patient from an electronic device;
(b) selecting, based on the first input, a first electronic template from a plurality of predetermined electronic templates;
(c) selecting, based on the first input, a first sensor network appliance and a first sensor device from a predetermined set of sensor devices;
(d) populating said first electronic template with a first set of information comprising protected health information, a second set of information comprising non-protected health information, an appliance parameter for said first sensor network appliance, and a sensor parameter for said first sensor device;
(e) providing said first electronic template to said first sensor network appliance;
(f) downloading to said first sensor network appliance a configuration file for said first sensor device; and
(g) electronically pairing said first sensor network appliance with said first sensor device using said appliance parameter, said sensor parameter, and said configuration file.

2. The method of claim 1 further comprising the steps of:
(h) monitoring said patient with said first sensor device, wherein the monitoring comprises receiving measurement information related to at least one vital sign of said patient;
(i) uploading the measurement information to a predetermined database; and
(j) providing the measurement information to a care team member.

3. The method of claim 1 wherein the first input comprises:
(i) the referring physician National Provider Identifier (“NPI”) or name;
(ii) Protected Health Information (“PHI”) for the patient or the patient's social security number;
(iii) an electronic prescription;
(iv) an electronic medical care plan parameter based on a type of said first sensor device; and
(v) a parameter for said first sensor network appliance.

4. The method of claim 1, wherein the first input includes information selected from the group consisting of: a medical protocol, a medical care plan, a secure user account, a software configuration file, sensor network appliance information, a sensor type, and combinations thereof.

5. The method of claim 1 wherein the first input includes a medical care plan comprising a prescription identifier, a duration for the medical care plan, at least one vital sign to be measured for the patient, a timing indication for the measurement of the at least one vital sign, a threshold depth value for each of the at least one vital sign, and a threshold check value for each of the at least one vital sign.

6. The method of claim 1, wherein said first electronic template includes information selected from the group consisting of: access control and authentication information, connection control and alert policies, data control and alert policies, and combinations thereof.

7. The method of claim 1, wherein the step of providing said first electronic template to said first sensor network appliance comprises:
(i) registering said patient to said first sensor network appliance;
(ii) downloading software from said server to said first sensor network appliance; and
(iii) providing information regarding measurements, alerts, and reports for monitoring said patient.

8. The method of claim 1 further comprising the steps of:
(h) selecting, based on the first input, a second electronic template from the plurality of predetermined electronic templates;
(i) selecting, based on the first input, a second sensor device from the predetermined set of sensor devices, where in the second sensor device is of a type different from a type of said first sensor device;
(j) populating said second electronic template with a third set of information, the appliance parameter for said first sensor network appliance, and a second sensor parameter for said second sensor device;
(k) providing said second electronic template to said first sensor network appliance;
(l) downloading to said first sensor network appliance a second configuration file for said second sensor device; and
(m) electronically pairing said first sensor network appliance with said second sensor device using said appliance parameter, said second sensor parameter, and said second configuration file.

9. A method for a health care provisioning protocol, the method comprising the steps of:
(a) receiving at a server a first input for a patient from an electronic device, wherein the first input comprises information regarding:
(i) an electronic prescription including a duration;
(ii) a referring physician;
(iii) a patient identifier;
(iv) at least one vital sign to be measured including an alert level;
(v) an identifier for a care team member;
(vi) a secure network appliance;
(vii) a sensor device from a predetermined set of sensor devices; and
(viii) a software file for said secure network appliance;
(b) selecting, based on the first input, an electronic template from a plurality of predetermined electronic templates;
(c) populating said electronic template with information from step (a);
(d) providing said electronic template to said sensor network appliance;
(e) downloading to said sensor network appliance:
(i) a portal application file;
(ii) a system application file;
(iii) a configuration file;
(iv) a pairing file;
(v) an account rights file;
(vi) a data application program interface file;
(vii) a first MAC address for said sensor network appliance; and
(viii) a second MAC address for said sensor device;
(f) electronically pairing said sensor network appliance with said sensor device;
(g) connecting said sensor network appliance to a remote data device;
(h) monitoring said patient with said sensor device, wherein the monitoring comprises receiving measurement information related to the at least one vital sign of said patient;
(i) uploading the measurement information to a predetermined database; and
(j) providing the measurement information to a care team member.

10. The method of claim 9, wherein the electronic template is selected from the group consisting of: a medical protocol template, a medical care plan template, a secure user account template, a software configuration file template, sensor network appliance template, a sensor type template, and combinations thereof.

11. The method of claim 9, further comprising the steps of:
(k) receiving at a server a second input for a patient from a second electronic device, wherein the second input comprises information regarding a change to at least one of:
(i) the electronic prescription including a duration;
(ii) the referring physician;
(iii) the patient identifier;
(iv) the at least one vital sign to be measured including an alert level;
(v) the identifier for a care team member;
(vi) the secure network appliance;
(vii) the sensor device from a predetermined set of sensor devices; and
(viii) the software file for said secure network appliance;
(l) populating said electronic template with information from step (k) to thereby create an adapted electronic template;
(m) providing said adapted electronic template to said sensor network appliance;
(n) monitoring said patient with said sensor device, wherein the monitoring comprises receiving measurement information related to the at least one vital sign of said patient;
(o) uploading the measurement information to a predetermined database based at least in part on said adapted electronic template; and
(p) providing the measurement information to a care team member based at least in part on said adapted electronic template.

12. A non-transitory machine-readable medium having stored thereon a plurality of executable instructions to be executed by a processor, the plurality of executable instructions comprising instructions to:
(a) receive at a server a first input for a patient from an electronic device;
(b) select, based on the first input, a first electronic template from a plurality of predetermined electronic templates;
(c) select, based on the first input, a first sensor network appliance and a first sensor device from a predetermined set of sensor devices;
(d) populate said first electronic template with a first set of information comprising protected health information, a second set of information comprising non-protected health information, an appliance parameter for said first sensor network appliance, and a sensor parameter for said first sensor device;
(e) provide said first electronic template to said first sensor network appliance;
(f) download to said first sensor network appliance a configuration file for said first sensor device; and
(g) electronically pair said first sensor network appliance with said first sensor device using said appliance parameter, said sensor parameter, and said configuration file.

13. The non-transitory machine-readable medium of claim 12 further comprising instructions to:
(h) monitor said patient with said first sensor device, wherein the monitoring comprises receiving measurement information related to at least one vital sign of said patient;
(i) upload the measurement information to a predetermined database; and
(j) provide the measurement information to a care team member.

14. A system for a health care provisioning protocol, comprising:
(a) a server for receiving a first input for a patient from an electronic device;
(b) first circuitry for selecting, based on the first input, a first electronic template from a plurality of predetermined electronic templates;
(c) second circuitry for selecting, based on the first input, a first sensor network appliance and a first sensor device from a predetermined set of sensor devices;
(d) third circuitry for populating said first electronic template with a first set of information comprising protected health information, a second set of information comprising non-protected health information, an appliance parameter for said first sensor network appliance, and a sensor parameter for said first sensor device;
(e) said first sensor network appliance operatively connected to said server, wherein said first sensor network appliance receives said first electronic template from said server;
(f) fourth circuitry for downloading from said server to said first sensor network appliance a configuration file for said first sensor device; and
(g) fifth circuitry for electronically pairing said first sensor network appliance with said first sensor device using said appliance parameter, said sensor parameter, and said configuration file.

15. The system of claim 14 further comprising:
(h) circuitry for monitoring said patient with said first sensor device, wherein the monitoring comprises receiving measurement information related to at least one vital sign of said patient;
(i) circuitry for uploading the measurement information to a predetermined database; and
(j) circuitry for providing the measurement information to a care team member.

16. The system of claim 14 further comprising:
(h) said first circuitry for selecting, based on the first input, a second electronic template from the plurality of predetermined electronic templates;
(i) said second circuitry for selecting, based on the first input, a second sensor device from the predetermined set of sensor devices, where in the second sensor device is of a type different from a type of said first sensor device;
(j) said third circuitry for populating said second electronic template with a third set of information, the appliance parameter for said first sensor network appliance, and a second sensor parameter for said second sensor device;
(k) said first sensor network appliance operatively connected to said server, wherein said first sensor network appliance receives said second electronic template from said server;
(l) said fourth circuitry for downloading to said first sensor network appliance a second configuration file for said second sensor device; and
(m) said fifth circuitry for electronically pairing said first sensor network appliance with said second sensor device using said appliance parameter, said second sensor parameter, and said second configuration file.
